(19) United States
(12) Patent Application Publication
(10) Pub. No.: US 2025/0329799 A1
(43) Pub. Date: Oct. 23, 2025

(54) SYSTEM AND METHOD FOR IMPROVED BATTERY SAFETY

(71) Applicant: Anthro Energy, Inc., San Jose, CA (US)

(72) Inventors: Daniel Gribble, San Jose, CA (US); Qi Zheng, San Jose, CA (US); Joseph K. Papp, San Jose, CA (US); David George Mackanic, San Jose, CA (US)

(73) Assignee: Anthro Energy, Inc., San Jose, CA (US)

(21) Appl. No.: 19/184,705

(22) Filed: Apr. 21, 2025

Related U.S. Application Data
(60) Provisional application No. 63/636,224, filed on Apr. 19, 2024.

(51) Int. Cl. H01M 10/42; H01M 10/0565

(52) U.S. Cl. CPC H01M 10/4235; H01M 10/0565; H01M 2300/0085

(57) ABSTRACT

A polymer-forming electrolyte can include polymer precursor(s), optional additive(s) (e.g., plasticizers; initiator; inhibitor; performance additives and/or safety additives such as nonflammable additives, flame-retardant additives, redox shuttle additives, SEI-forming additives, SEI-stabilizing additives, self-closing electrolyte additives, etc.; etc.), solvent(s) (e.g., polar solvent; salt-dissolving solvent; salt-coordinating solvent; diluent; safety solvent such as nonflammable solvent, noncombustible solvents, etc.; etc.), and/or salt(s). In some variants, the polymer-forming electrolyte can be cured (e.g., within a battery cell) to form a gel-electrolyte (e.g., between an anode and cathode of the battery cell, interspersed within the anode and the cathode, etc.).

### CROSS-REFERENCE TO RELATED APPLICATIONS

This application claims the benefit of U.S. Provisional Application No. 63/636,224 filed 19 Apr. 2024, which is incorporated in its entirety by this reference.

### TECHNICAL FIELD

This invention relates generally to the battery field, and more specifically to a new and useful electrolyte system in the battery field.

### BRIEF DESCRIPTION OF THE FIGURES

FIG. 1 is a schematic representation of an example electrolyte system (e.g., uncured electrolyte).

FIGS. 2A and 2B are schematic representations of examples of a battery including an example electrolyte system (e.g., a cured or uncured electrolyte solution).

FIG. 3 is a schematic representation of an example of a cured gel electrolyte system.

### DETAILED DESCRIPTION

The following description of the embodiments of the invention is not intended to limit the invention to these embodiments, but rather to enable any person skilled in the art to make and use this invention.

### 1. Overview

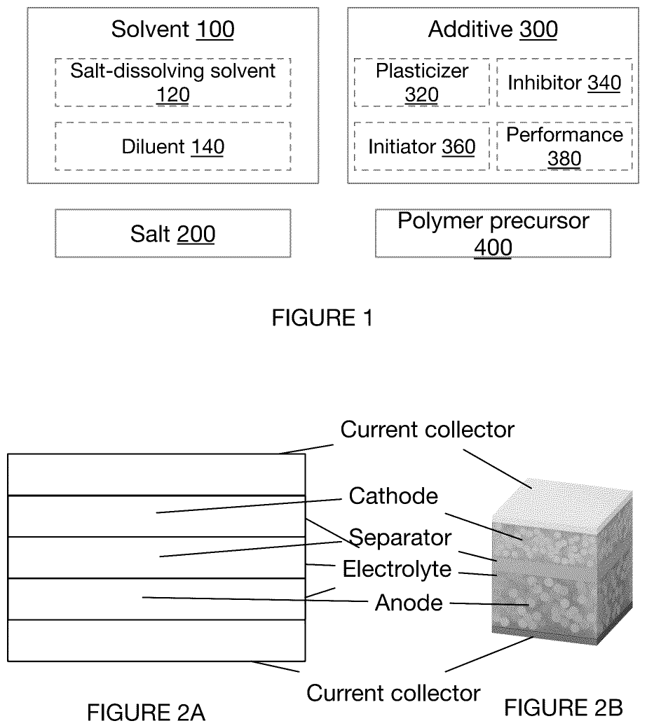

As shown in FIG. 1, a formulation 10 for a polymer electrolyte can include polymer precursor(s) 400, optional additive(s) 300 (e.g., plasticizers 320; initiator 360; inhibitor 340; performance additives and/or safety additives 380 such as nonflammable additives, flame-retardant additives, redox shuttle additives, SEI-forming additives, SEI-stabilizing additives, self-closing electrolyte additives, etc.; etc.), solvent(s) 100 (e.g., polar solvent; non-polar solvent; salt-dissolving solvent 120; salt-coordinating solvent; diluent 140; safety solvent such as nonflammable solvent, noncombustible solvents, etc.; etc.), salt(s), and/or any suitable components.

The formulation is preferably used within a battery (e.g., a battery as shown for example in FIG. 2A or FIG. 2B that can include a cathode current collector, a cathode, a separator, an electrolyte, an anode, an anode current collector, etc.) to form a battery with a polymeric electrolyte (e.g., gel-polymer electrolyte where the gel polymer electrolyte is intercalated throughout the cathode, separator, and anode or a subset of those components). In some variants, the gel-polymer electrolyte can additionally or alternatively act as a separator (e.g., when a separate freestanding gel-polymer electrolyte is cured and sandwiched between electrodes, where the electrodes have been permeated with electrolyte). However, the formulation could be used in a capacitor, fuel cell, electrolyzer, and/or in any suitable system.

### 2. Examples

In an example, a gel electrolyte formulation (e.g., prior to curing) can include: a nonflammable and/or high boiling point (BP) (e.g., with a boiling point greater than about 150° C.) solvent (10-50 wt %) such as a phosphate (e.g., DMMP, TEP, TMP, TFEP), a phosphite (e.g., TMPi, TEPi), a carbonate (e.g., FEC, PC, EC, 1,2-butylene carbonate, 2,3-butylene carbonate, 1,2-pentylene carbonate, 2,3-pentylene carbonate, etc.), a sulfate and/or sulfite (e.g., ethylene sulfite, sulfolane, 1,3,2-Dioxathiolan-2,2-oxide (DTD), 1,3-propylene sulfite (PS), etc.), an ether (e.g., diglyme, triglyme, tetraglyme, etc.), an ionic liquid (e.g., with a cation selected from 1-alkyl-3-methyl imidazolium, N-alkyl pyridinium, N-alkyl-N-methyl piperidinium, tetraalkyl-ammonium, tetraalkyl phosphonium, N-alkyl-N-methyl pyrrolidinium, 1,2-dialkyl-pyrazolium, N-alkyl-thiazolium, trialkylsulfonium, wherein each alkyl group can be independently selected from methyl, ethyl, propyl, butyl, pentyl, hexyl, heptyl, octyl, nonyl, decyl, undecyl, dodecyl, aryl, naphthyl group or variations of the preceding with one or more hydrogen atom replaced with a fluorine atom such as 1-methyl-3-methylimidazole, 1-ethyl-3-methylimidazole, 1-propyl-3-methylimidazole, 1-butyl-3-methylimidazole, 1-hexyl-3-methylimidazole, 1-octyl-3-methylimidazole, 1-decyl-3-methylimidazole, 1-dodecyl-3-methylimidazole, 1-butyl-2,3-dimethylimidazolium, 1,3-di(N,N-dimethylaminoethyl)-2-methylimidazolium, 4-methyl-N-butyl-pyridinium, N-octylpyridinium, tetraethylammonium, tetrabutylammonium, etc.; and with an anion selected from hexafluorophosphate, ethyl sulfate, dicyanamide, trifluoromethanesulfonate, tetrafluoroborate, bis(oxalate)borate, difluorobis(oxalate)borate, bis(fluorosulfonyl)imide, bis(trifluoromethane)sulfonimide, etc.), esters (e.g., methyl methanoate, methyl ethanoate, methyl propanoate (MP), methyl butanoate (MB), ethyl methanoate, ethyl ethanoate, ethyl propanoate (EP), ethyl butanoate (EB), propyl methanoate, propyl ethanoate, propyl propanoate (PP), propyl butanoate, γ-butyrolactone (GBL), γ-valerolactone (GVL), 8-valerolactone (DVL), 2-acetylbutyrolactone (ABL), 8-nonalactone, γ-nonalactone, γ-octalactone, γ-decalactone, γ-undecalactone, β-methyl-γ-octalactone, etc.), amides (e.g., diethylformamide, tetramethylurea, N-vinylacetamide, N-vinylpyrrolidone, 2-pyrrolidone, N-methylformamide, N-methyl-2-pyrrolidone, N-formylmorpholine, formamide, 1,3-dimethyl-2-imidazolidinone, dimethylacetamide, dimethylformamide, 1,1-dimethylurea, N,N′-dimethylpropyleneurea (DMPU), etc.), and/or a nitrile (e.g., SN, ADN, etc.); a salt (e.g., LiPF₆, lithium bis(oxalate)borate (LiBOB), lithium difluorobis(oxalate)borate (LiDFOB), lithium bis(fluorosulfonyl)imide (LiFSI), lithium bis(trifluoromethane)sulfonimide (LiTFSI), etc.) at high concentrations (3-7 M) in the nonflammable or high BP solvent (e.g., 10-80 wt % salt or any subset or value contained therein); a diluent (e.g., where the salt is not soluble in and/or has a low solubility in the diluent) to lower viscosity and effective salt concentration while preserving solvation structure of the salt within the nonflammable or high BP solvent (30-90 wt %) such as a fluorinated ether (e.g., HFE, PFE, TTE, etc.), a fluorinated ester (e.g., methyl 3,3,3-trifluoropionate (MTFP), methyl 2-fluoroisobutyrate (MFB), a fluorinated carbonate (e.g., methyl 2,2,2-trifluoroethyl carbonate (FEMC), tri (2,2,2-trifluoroethyl)borate (TFEB), fluoroethylene carbonate (FEC), fluoromethyl methyl carbonate, fluoromethyl fluoromethyl carbonate, fluoroethyl fluoromethyl carbonate, etc.), a fluorobenzene, a fluoroalkane (e.g., perfluorooctane, perfluoro-2-methylpentane, perfluoro-1,3-dimethylcyclohexane, perfluorodecalin, perfluoropentane, perfluoromethylcyclohexane, fluorocyclohexane, fluorocyclopropane, perfluorotripentylamine,1,1,2-trichloro-1,2,2-trifluoroethane, etc.), and/or a phosphazene (e.g., PFPN); a crosslinking polymer precursor (1-20 wt %) such as an oligomer resin (e.g., multifunctional acrylate, multifunctional urethane acrylate, multifunctional polyether acrylate, multifunctional polyester acrylate, multifunctional polycarbonate acrylate, multifunctional polyimide acrylate, multifunctional polyurea acrylate, multifunctional methacrylate, multifunctional urethane methacrylate, multifunctional polyether methacrylate, multifunctional polyester methacrylate, multifunctional polycarbonate methacrylate, multifunctional polyimide methacrylate, multifunctional polyurea methacrylate, diacrylate, triacrylate, tetraacrylate, pentaacrylate, hexaacrylate, dimethacrylate, trimethacrylate, tetramethacrylate, pentamethacrylate, hexamethacrylate, trimethylolpropane triacrylate, divinylbenzene, etc.), an optional monofunctional monomer (e.g., methyl acrylate, butyl acrylate, butyl methacrylate, methyl methacrylate, fluorinated acrylates, fluorinated methacrylates, phosphate acrylates, vinyl acrylates, vinyl methacrylates, vinyl acetate, vinyl formate, vinyl neodecanoate, vinyl propionate, styrene, 4-vinyltoluene, etc.); a radical initiator (e.g., azo initiators such as dimethyl 2,2′-azobis(2-methylpropionate, 2,2′-azobis(2,4-dimethyl-4-methoxyvaleronitrile), 1,1′-azobis(cyclohexanecarbonitrile) (ACHN), azobisisobutylonitrile (AIBN), 1,1′-azobis-1,2,3-triazole, 2,2′-azobis(2,4-dimethylvaleronitrile), 2,2-azobis(2-methylbutyronitrile), 2,2′-azobis(N-butyl-2-methyl propionamide), 2,2′-azobis(2,4,5-trimethylpentane), 2,2′-azobis[2-(2-imidazolin-2-yl) propane]dihydrochloride, etc.; peroxides such as di-tert-butyl peroxide, benzoyl peroxide, methyl ethyl ketone peroxide, acetone peroxide, tert-butyl hydroperoxide, cumene hydroperoxide, dicumyl peroxide, etc.; persulfates such as ammonium persulfate, sodium persulfate, potassium persulfate, etc.; photoinitiators for ultraviolet and/or electron beam curing such as silver olefin complexes, diaryliodonium and/or triarylsulfonium salts with anions such as hexafluoroantimonate and/or fluorinated tetraphenyl borates, acylates or methacrylates, camphorquinone, acetophenone, 4′-hydroxyacetophenone, 3′-hydroxyacetophenone, benzophenone, 3-methylbenzophenone, 2-methylbenzophenone, 3,4-dimethylbenzophenone, 3-hydroxybenzophenone, 4-hydroxybenzophenone, 4,4′-dihydroxybenzophenone, 4-benzoylbenzoic acid, 2-benzoylbenzoic acid, methyl 2-benzoylbenzoate, 4,4′-carbonyldiphthalic anhydride, 4-(dimethylamino)benzophenone, 4,4′-bis(dimethylamino)benzophenone, 4,4′-bis(diethylamino)benzophenone, 4-phenylbenzophenone, 1,4-dibenzoylbenzene, 4-(p-tolylthio)benzophenone), dibenzosuberone, benzil, p-anisil, methylbenzoylformate, 9,10-phenanthrenequinone, 2-benzoyl-2-propanol, 2-hydroxy-4′-(2-hydroxyethoxy) 2-methylpropiophenone, 1-benzylcyclohexanol, benzoin, anisoin, benzoin methyl ether, benzoin ethyl ether, benzoil propyl ether, benzoin isobutyl ether, 2,2-diethoxyacetophenone, benzil dimethylketal, 2-methyl-4′-(methylthio) 2-morpholinopropiophenone, 2-benzyl-2-(dimethylamino) 4′-morpholinobutyrophenone, 1-([1,1′-biphenyl]-4-yl)-2methyl-2-morpholinopropan-1-one, 2-isonitrosopropiophenone, 2-isonitrosopropiophenone, anthraquinone, 2-ethylanthraquinone, sodium anthraquinone 2-sulfonate, 2-chlorothioxanthone, 1-chloro 4-propoxythioxanthone, 2-isopropylthioxanthone, 2,4-dimethylthioxanthen-9-one, 2,7-di methoxythioxanthone, 2,2′-bis(2-chlorophenyl)-4,4′,5,5′tetraphenyl-1,2′-biimidazole, 2,2′-bis(2-chlorophenyl)-4,4′,5,5′tetraphenyl-1,1′-biimidazole, diphenyl(2,4,6-trimethylbenzoyl)phosphine oxide, phenylbis(2,4,6-trimethylbenzoyl)phosphine oxide, ethyl(mesitylcarbonyl)phenylphosphinate, lithium phenyl-(2,4,6trimethylbenzoyl)phosphinate, ferrocene, bis[2,6-difluoro3-(1H-pyrrol-1-yl)phenyl]titanocene, etc.); a plasticizer (1-20 wt %) such as propylene carbonate (PC), fluoroethylene carbonate (FEC), ethylene carbonate (EC), trimethylphosphate (TMP), and/or triethylphosphate (TEP); and an optional additive (e.g., 1-5 wt %) to improve nonflammability, solid-electrolyte interface (SEI) formation, and/or aid in conductivity (e.g., (ethoxy)pentafluorocyclotriphosphazene (PFPN), vinylene carbonate (VC), FEC, 1-fluoroethyl methyl carbonate (FEMC), sultones, nitriles, lithium difluorophosphate, ethylene sulfate (DTD), difluoro ethylene carbonate, 4-vinyl-1,3-dioxolan-2-one, tris(trimethylsilyl)phosphite, tris(trimethylsilyl)Phosphate, tris(trimethylsilyl)borate, vinyltris(2-methoxyethoxy) silane, 2-cyanoethyltriethoxysilane, tetraethyl orthosilicate, tripropargyl phosphate, methylene methanedisulfonate, 2,2,2-trifluoro-N,N-dimethylacetamide, 4-fluoro-N,N-dimethylbenzenesulfonamide, N—N-heptafluorobutyric anhydride, etc.). In some variants, a concentrated salt solution can be formed (e.g., in a salt-dissolving solvent) that can then be diluted (e.g., with a diluent). The formulation from this example can be cured (e.g., to form a gel-polymer) in situ (for instance using thermal energy, optical energy, electrochemical energy, in a manner as described in U.S. patent application Ser. No. 18/443,716 titled ‘GEL ELECTROLYTE COMPOSITION FOR A BATTERY AND A METHOD OF IMPLEMENTATION’ filed 16 Feb. 2024 which is incorporated in its entirety by this reference, etc.). In variations of this specific example, the nonflammable and/or high BP solvent can refer to a single solvent with both nonflammable and high BP properties, a mixture of one or more nonflammable solvents with one or more high BP solvents, a mixture (inclusive of a singular compound) of nonflammable solvents, a mixture (inclusive of a singular compound) of high BP solvents, and/or other suitable solvent systems (e.g., that can dissolve, solubilize, disperse, etc. that salt(s)).

### 3. Technical Advantages

Variants of the technology can confer one or more advantages over conventional technologies.

First, variants of the technology that can result in improved safety (e.g., reduced flammability) in batteries. For example, a battery that includes a polymer electrolyte can undergo a change in thickness of about 60% upon overcharging (e.g., charging 1 Ah cells from 100% SOC to 200% SOC at 1° C.) whereas a battery with a liquid electrolyte can result in a thickness change of >400% under the same conditions. In another example, a battery with a polymer electrolyte can withstand penetrations without undergoing and/or by limiting the intensity of thermal runaway (e.g., without an unmitigated rise in temperature resulting in catastrophic failure of the battery cell, without a temperature exceeding about 80° C.) and/or catching fire whereas a battery with a liquid electrolyte undergoes thermal runaway (e.g., temperature exceeds about 80° C.) after two punctures (and even after a single puncture the temperature increases and remains elevated until catastrophic failure).

Second, variants of the technology can leverage the use of solvent systems (e.g., a combination of salt-dissolving and non-salt dissolving solvents) to result in improved battery safety. For instance, salts can have local high concentrations in the salt-dissolving component of the solvent can result in an increased BP, increased flash point, reduced flammability in the solvent, and/or can otherwise improve stability of the electrolyte. Relatedly, the inclusion of a diluent in the solvent system can result in reduced viscosity thereby improving ionic conductivity of the solvent and/or wetting behaviour of the electrolyte on the anode, cathode, and/or separator (in addition to or as an alternative to other potential benefits of the diluent such as fire retardant properties).

Third, the inventors have discovered that the polymeric precursors can be dissolved in the non-salt dissolving solvent (as well as the salt-dissolving solvent) enabling a homogeneous gel-polymer electrolyte to be formed (e.g., upon curing of the polymeric precursors). Moreover, the inventors have found that the salt can coordinate with the polymeric precursors resulting in both precipitating or otherwise being removed from solution (e.g., upon curing of the polymer). To avoid or reduce the extent to which the salt and/or polymer precursors crash out of solution, plasticizer(s) can be included in the electrolyte precursor. Relatedly, when the cured polymeric electrolyte is formed and used within a battery, the battery can undergo reduced swelling, improved safety (e.g., reduced risk of thermal runaway, reduced risk of flame, etc.), and/or other suitable properties (e.g., as compared to a battery with otherwise the same components but excluding the polymer electrolyte).

However, further advantages can be provided by the system and method disclosed herein.

### 4. Battery

As shown for instance in FIG. 2A, a battery can include a current collector (e.g., a cathode current collector, an anode current collector, etc.), a cathode, a separator, an electrolyte, an anode, a housing, and/or any suitable components. The electrolyte is preferably a polymer-gel electrolyte (e.g., formed by treating a polymer electrolyte formulation as described below, physical gel, chemical gel, etc.), but can be any suitable electrolyte (e.g., a liquid electrolyte that includes safety monomers, safety oligomers, safety polymers, etc. without forming a gel throughout).

The current collector preferably functions as a support for an electrode and conducts electrons into and out of the electrode. For instance, a cathode current collector can support a cathode and an anode current collector can support and anode. The cathode current collector and anode current collector can be the same or different. The current collectors can be foil, foam, mesh, carbon coated, and/or be any type of current collector. The current collectors are typically made from aluminium (particularly common for the cathode), copper (particularly common for the anode), nickel, titanium, stainless steel, and/or metalized plastics (e.g., mylar, PET, polyester, polyacrylonitrile, cellulose nanofibers, polypropylene, etc. with one or two metallized layers such as aluminium, copper, nickel, titanium, alloys, etc.). However, the current collectors can be made of any material and/or have any form.

The cathode (e.g., material thereof) functions to undergo reduction during discharge (e.g., electrons enter the cathode during discharge and leave the cathode during charging). The cathode can include binders (e.g., to bind the cathode active material together, to bind the cathode active material to the current collector, etc.), cathode active material (e.g., the material that participates electrochemically), conductive material (e.g., to increase an electrical conductivity within the cathode active material, to improve shuttling of electrons between the current collector and the cathode active material, etc.), and/or can include any suitable material(s). The cathode active material is preferably a lithium-containing active material (e.g., lithium nickel cobalt manganese oxide (NMC, NCM) such as NMC 622, NMC 811, NMC532, NMC111, etc.; lithium iron phosphate (LFP); lithium manganese iron phosphate (LMFP); lithium nickel manganese spinel (LNMO); lithium nickel cobalt aluminium oxide (NCA); lithium manganese oxide (LMO); lithium cobalt oxide (LCO); lithium titanate (LTO); lithium transition metal borates such as borophosphates (BPO), borosilicates (BSiO), borosulfates (BSO), etc.; lithium vanadium phosphate (LVP); etc.). However, the cathode active material can additionally or alternatively include sodium-containing active material (e.g., sodium ion battery), potassium-containing cathode active material (e.g., potassium ion battery), magnesium-containing cathode active material (e.g., magnesium ion battery), calcium-containing cathode active material (e.g., calcium ion battery), zinc-containing cathode active material (e.g., zinc ion battery), aluminium-containing cathode active material (e.g., aluminium ion battery), and/or any suitable cathode active material can be used. The cathode active material is typically particulate (e.g., nanoparticle, mesoparticles, macroparticle, etc.), but can form thin films and/or any morphology. Examples of binders include: polyvinylidene fluoride (PVDF), styrene butadiene copolymer (SBR), carboxymethyl cellulose (CMC), polyacrylic acid (PAA), poly(vinyl alcohol) (PVA), humics, poly(3,4-ethylenedioxythiophene)-polystyrenesulfonate (PEDOT:PSS), chitosan, alginate, combinations or blends thereof, and or other suitable binder(s). Examples of conductive additives include: carbon black, carbon nanotubes, graphite, graphene, fullerenes, carbon fiber (VGCF), Super P Li, S—O, KS-6, KS-15, SFG-6, SFG-15, 350G, acetylene black, Ketjen black, metal nanoparticles, and/or any suitable conductive additive or combination of conductive additives can be used.

The anode (e.g., material thereof) functions to undergo oxidation during battery discharge (e.g., electrons leave the anode during discharge and enter the anode during charging). The anode can include binders (e.g., to bind the anode active material together, to bind the anode active material to the current collector, etc. analogous to a binder as described above for a cathode), anode active material (e.g., the material that participates electrochemically), conductive material (e.g., to increase an electrical conductivity within the anode active material, to improve shuttling of electrons between the current collector and the anode active material, etc. analogous to a conductive additive as described above for a cathode), and/or can include any suitable material(s). The anode active material can be carbon based (e.g., graphite, graphitic carbon, carbon fibers, carbon nanotubes, carbon spheres, carbon nanorods, etc.), alloy materials (e.g., aluminium, tin, magnesium, silver, antimony, their alloys, etc.) conversion-type materials (CTAM such as transition-metal sulfides, oxides, hydroxides, phosphides, nitrides, carbides, fluorides, selenides, chalcogenides, oxalates, niobates, etc.), silicon materials, combinations thereof (e.g., mixtures of graphite and silicon), lithium metal, and/or any suitable anode active material. The anode active material is typically particulate (e.g., nanoparticle, mesoparticles, macroparticle, etc.), but can form thin films and/or any morphology. In some variants, the battery does not include an anode.

The separator functions to electrically isolate the anode from the cathode (e.g., prevent electrical short circuiting) while allowing ions (e.g., Li⁺) to pass between the cathode and the anode. The separator can also function to improve the safety of the battery (e.g., by closing pores above a threshold temperature thereby shutting off ion transport) and/or can otherwise function. The separator can be porous, fibrous (e.g., a web, sheet, mat, etc. or oriented or random fibers), and/or have any suitable structure. The porosity of the separator is typically between about 30-50%. However, the porosity can be lower than 30% or higher than 50%. The separator can be made of polymers (e.g., polyolefin such as polyethylene, polypropylene, polybutene, polymethylpentene, etc.; poly(tetrafluoroethylene); poly(vinyl chloride); polyimides; etc.), nonwoven fibers (e.g., cotton, nylon, glass, polyester, etc.), natural substances (e.g., wood, rubber, asbestos, etc.), and/or of any suitable material. In some variants, the gel electrolyte (e.g., as described below) can act as a separator (e.g., when a separate freestanding gel-polymer electrolyte is cured and sandwiched between electrodes, where the electrodes have been permeated with electrolyte).

### 5. Electrolyte

The electrolyte functions to transport ions between the cathode and the anode (e.g., through the separator). Additional functionalities can be conferred to the electrolyte based on additives included therein (e.g., solid-electrolyte interface (SEI) formation, flame retardant, flame suppression, overcharge protection, H₂O and/or HF concentration control, etc.). The electrolyte is preferably a gel electrolyte (e.g., a polymer including one or more plasticizers such as a solvent, additive, etc.). However, the electrolyte can be a solid (e.g., polymeric solid), liquid, and/or can be any suitable state. The polymer matrix is preferably formed by curing (e.g., polymerizing polymer precursor(s)) within an electrolyte formulation, where the polymer precursors are preferably cured within the battery (e.g., in situ cure). Examples of curing methods include, but are not limited to, thermal radical initiation, thermal cationic initiation, thermal anion initiation, UV radical initiation, UV cation initiation, UV anion initiation, electron beam (EB) radical initiation, EB cation initiation, EB anion initiation, condensation polymerization (e.g., epoxide condensation), ring opening polymerization (e.g., dioxolane ring opening polymerization, caprolactone ring opening, lactone ring opening, lactam ring opening, caprolactam ring opening, etc.), step-growth polymerization, and/or chain-growth polymerization (e.g., using one or more of the aforementioned initiation mechanisms to begin the chain-growth polymerization). However, the polymer matrix can otherwise be cured.

As shown for example in FIG. 1, the electrolyte can include a solvent, a salt, a polymer precursor, an additive, and/or any suitable components. In some variants, the solvent, salt, and/or additive can additionally or alternatively act as plasticizers for the polymer formed by curing the polymer precursor. Similarly, while given distinct names, the same material can act as a solvent and/or additive (e.g., a material can be included in the electrolyte for a plurality of reasons). The electrolyte is preferably 40-90% solvent, 10-35% salt, 1-20% polymer precursor, 1-20% plasticizer, and 1-5% (cell) additive (e.g., where % can refer to weight percent, volumetric percent, stoichiometric percent, etc. and the total percentage adds up to 100%). However, the electrolyte can vary from these percentages (e.g., when a component is performing a plurality of functions the concentrations can be combined such as a solvent that also acts as an additive can result in a composition that is 40-99% solvent, 10-35% salt and 1-20% polymer precursor; for a solventless or nearly solvent-free electrolyte the solvent fraction can be removed and/or redistributed; etc.). As a specific example of an electrolyte composition, the electrolyte can include about 50% diluent, about 25% salt, about 20% salt-dissolving solvent, and about 5% combined polymer precursor and plasticizer, where the percentages can refer to weight percent, stoichiometric percent, volume percent, and/or other suitable percents.

The solvent is preferably a solvent mixture (e.g., including two or more solvents). The solvent mixture preferably includes miscible solvents (e.g., forming a homogeneous mixture when added together). However, the solvent mixture could include immiscible solvents (e.g., where the polymer precursor, an additive, etc. can function to improve miscibility of the solvents). However, a neat solvent could be used (e.g., in variants where the polymer precursors act as a solvent).

The solvent preferably includes a salt-dissolving solvent (e.g., salt-coordinating solvent) and a diluent (e.g., non-salt dissolving, poorly-salt dissolving, etc. solvent). Often, the salt-dissolving solvent is polar (usually aprotic, but potentially protic) while the diluent is non-polar and/or less polar than the salt-dissolving solvent. However, the diluent and the salt-dissolving solvents can have any suitable proticity and/or polarity. In some variants, one or more polymer precursors can act as a solvent.

The salt-dissolving solvent functions to dissolve the salt. The salt-dissolving solvent preferably enables a high salt concentration (e.g., >3 molar such as 3 M, 4 M, 5 M, 6 M, 7 M, 8 M, 9 M, 10 M, 12 M, 18 M, etc.). However, the salt-dissolving solvent can enable a lower salt concentration.

Examples of salt-dissolving solvents include: carbonates (e.g., ethylene carbonate (EC), diethyl carbonate (DEC), dimethyl carbonate (DMC), ethyl methyl carbonate (EMC), propylene carbonate (PC), vinylene carbonate (VC), 1,2-butylene carbonate, 2,3-butylene carbonate, 1,2-pentylene carbonate and 2,3-pentylene carbonate etc.), ethers (e.g., dimethoxyethane (DME), diethyl ether, diglyme, triglyme, tetraglyme, etc.), esters (e.g., methyl formate (MF), ethyl formate (EF), methyl propionate (MP), methyl butanoate (MB), ethyl formate (EF), ethyl acetate (EA), ethyl propionate (EP), propyl formate, propyl acetate (PA), propyl propionate (PP), etc.), sulfates and/or sulfites (e.g., ethylene sulfite, sulfolane, etc.), phosphates (e.g., trimethylphosphate (TMP), triethylphosphate (TEP), tributylphosphate (TBP), triphenylphosphate (TPP), methyl P,P-bis(2,2,2-trifluoroethyl)phosphate (BMP), dimethyl methyl phosphate (DMMP), diethyl ethylphosphate (DEEP), etc.), phosphites (e.g., trimethylphosphite (TMPi)), phosphazenes (e.g., Phoslyte™), nitriles (e.g., succinonitrile (SN), malononitrile, glutaronitrile, adiponitrile (ADN), 1,1-bis(20cyanoethoxy) ethane, 1,1-dicyano-2-butene, hexane-1,3,6-tricarbonitrile, 1,2,3-tris(2-cyanoethoxy) propane, acetonitrile, benzonitrile, phthalonitrile, isobutyronitrile, cyanoform, etc.), heterocyclic organic compounds (e.g., 1,2-dioxane, 1,3-dioxane, 1,4-dioxane, 1,2-dioxolane, 1,3-dioxolane, 1,2-dioxetane, 1,3-dioxetane, tetrahydrofuran, furan, etc.), ionic liquids (e.g., with one or more cation and one or more anion, where the cation can be selected from 1,3-dimethylimidazolium, N-methylpyridinium, 1-ethyl-3-methylimidazolium (EMIM), 1-butyl-3-methylimidazolium (BMIM), 1-octyl-3-methylimidazolium (OMIM), 1-decyl-3-methylimidazolium (DMIM), 1-dodecyl-3-methylimidazolium (dodecylMIM), 1-butyl-2,3-dimethylimidazolium (BMMIM or DBMIM), 1,3-di(N,N-dimethylaminoethyl)-2-methylimidazolium (DAMI), 4-methyl-N-butyl-pyridinium (MBPy), N-octylpyridinium (C8Py), trihexyl(tetradecyl)phosphonium (P_{6,6,6,14}), tributyl(tetradecyl) phosphonium (P_{4,4,4,14}); where the anion can be selected from hexafluorophosphate, tetrafluoroarsenate, perchlorate, tetrafluoroborate, triflate, chloride, bromide, iodide, tris(pentafluoroethyl)trifluorophosphate, bis(fluorosulfonyl)imide, cyclo-difluoromethane-1,1-bis(sulfonyl)imide, cyclo-hexafluoropropane-1,1-bis(sulfonyl)imide, bis(trifluorosulfonyl)imide, cyclo-hexafluoropropane-1,1-bis(sulfonyl)imide, bis(oxalate)borate, difluoro (oxalato)borate, bis(monofluoromalonate)borate, tetracyanoborate, 4,5-dicyano-1,2,3-triazolate, 2-trifluoromethyl-4,5-dicyanoimidazole, 4,5-dicyano-2-(pentafluorylethyl)imidazole, etc.), and/or other suitable solvent(s). In a specific example, where the salt dissolving component includes an ionic liquid, the ionic liquid can have the same anion as the salt (which can be beneficial for ensuring a high solubility of the salt in the ionic liquid, reducing potential side reactions within the electrochemical cell, etc.).

In some variants, the salt-dissolving solvent can be a mixture (e.g., of two or more salt-dissolving solvents, a solvent mixture that enables salt to dissolve in the mixture, etc.). For example, a linear and cyclic carbonate can be mixed (e.g., in a 1:1, 3:7, 7:3, etc. by mass, volume, stoichiometry, etc.) to form the salt-dissolving solvent (e.g., cosolvents). As a second example, a solvent mixture can include a nonflammable (e.g., non-volatile, high vapor pressure, etc.) and a flammable (e.g., volatile, low vapor pressure, etc.) component as salt-dissolving solvents. In one variant of the second specific example, phosphates, phosphonates, and/or phosphites can be included as a nonflammable polar solvent (e.g., that can dissolve salts(s), preferably with a high salt concentrations such as 30-60 wt % salt to solvent to form stable SEI).

The diluent preferably functions to reduce a concentration of the salt and/or salt-dissolving solvent (which is often flammable but can additionally or alternatively be expensive or otherwise desirable to reduce a concentration and/or amount present within the battery) while maintaining a solvation structure of the salt within the salt-dissolving solvent (e.g., which can be measured using spectroscopy such as FTIR, Raman, NMR, etc.). The diluent can additionally or alternatively lower the viscosity of the solvent. The diluent preferably does not substantially dissolve or solubilize salt (e.g., to maintain a high local salt concentration within the salt-dissolving solvent), which can help maintain the solvation structure of the salt within the salt-dissolving solvent. The diluent preferably has a high boiling point (e.g., ≥40° C., ≥50° C., ≥60° C., ≥75° C., ≥100° C., ≥150° C., ≥200° C., etc.). The diluent (and/or resulting electrolyte) preferably has a high flash point (e.g., ≥23° C., ≥30° C., ≥35° C., ≥40° C., ≥50° C., ≥75° C., ≥100° C., ≥150° C., ≥200° C., etc.). However, the diluent can have any suitable boiling point, flash point, autoignition temperature, and/or fire point.

The diluent preferably has a low viscosity (e.g., ≤5 cP, ≤4 cP, ≤3 cP, ≤2 cP, ≤1 cP, ≤0.7 cP, ≤0.5 cP, ≤0.4 cP, ≤0.3 cP, ≤0.2 cP, etc.) at a target temperature (e.g., operating temperature, room temperature, 20° C., etc.). However, the diluent can have any suitable viscosity (e.g., when an additive or other component is included that lowers the viscosity).

The diluent is preferably 30-90% (by weight, by volume, by stoichiometry, etc.) of the solvent mixture (where the remainder adding up 100% is the salt-dissolving solvent). However, the diluent can be any suitable percentage of the solvent mixture.

Examples of diluents include: phosphazenes (e.g., hexa(methoxy)cyclotriphosphazene (HMOCPN), (ethoxy)pentafluorocyclotriphosphazene (PFPN), (phenoxy)pentafluorocyclotriphosphazene (FPPN), etc.), fluorinated phosphates (e.g., tris(2,2,2-trifluoroethyl)phosphate (TFP), bis(2,2,2-trifluoroethyl)methylphosphate (TFMP), bis(2,2,2-trifluoroethyl)ethylphosphate (TFEP), tris(2,2,2-trifluoroethyl) borate (TTFEB), etc.), fluorinated phosphites (e.g., tris(2,2,2-trifluoroethyl)phosphite (TTFPi)), fluorinated esters (e.g., methyl 3,3,3-trifluoropropanoate (MTFP), ethyl trifluoroacetate (ETFA), 2,2,2-trifluoroethylacetate (TFEA), methyl pentafluoropropionate (MPFP), ethyl 3,3,3-trifluoropyruvate (ETFPy), tris(2-fluoroethyl)borate (TFEB), etc.), fluorinated carbonates (e.g., fluoroethylene carbonate (FEC), methyl 2,2,2-trifluoroethyl carbonate (MTFEC), ethyl 2,2,2-trifluoroethyl carbonate (ETFEC), propyl 2,2,2-trifluoroethyl carbonate (PTFEC), methyl 2,2,2,2′,2′,2′-hexafluoro-isopropyl carbonate (MHFPC), ethyl 2,2,2,2′,2′,2′-hexafluoro-isopropyl carbonate (EHFPC), di-2,2,2-trifluoroethyl carbonate (DTFEC), trifluoropropylene carbonate (TFPC), trifluorobutylene carbonate (TFBC), difluorovinyl carbonate (DFVC), trifluoroethyl methyl carbonate (TFEMC), bis(2,2,2-trifluoroethyl) carbonate (DFDEC), etc.), fluorinated ethers (e.g., bis(2,2,2-trifluoroethyl) ether (BTFE), 1,1,2,2-tetrafluoroethyl 2,2,2 trifluoroethyl ether, ethyl nonafluorobutyl ether, methyl nonafluorobutyl ether, difluoromethyl 2,2,3,3-tetrafluoropropyl ether, 1,1,1,2,2,3,4,5,5,5-decafluoro-2-methoxy-4 (trifluoromethyl)pentane, ethyl 1,1,2,2-tetrafluoroethyl ether, ethyl 1,1,2,3,3,3-hexafluoropropyl ether, fluoromethyl 1,1,1,3,3,3-hexafluoroisopropyl ether, 1,1,2,3,3,3-hexafluoropropyl methyl ether, hexafluoroisopropyl methyl ether, methyl 2,2,3,3,3-pentafluoropropyl ether, methyl 1,1,2,2-tetrafluoroethyl ether, 1H,1H,5H-octafluoropentyl 1,1,2,2-tetrafluoroethyl ether, 3,3,4,4-tetrafluorotetrahydrofuran, 1,1,2,2-tetrafluoroethyl-2,2,3,3-tetrafluoropropyl ether (TTE), 2,2-dimethoxy-4-(trifluoromethyl)-1,3-dioxolane (DTDL), tris(2,2,2-trifluoroethyl)orthoformate (TFEO), hexafluoropropylene oxide, perfluoroether (PFE), hydrofluorethers (HFE), etc.), fluorobenzenes (e.g., monofluorobenzene, 1,2-difluorobenzene, 1,3-difluorobenzene, 1,4-difluorobenzene, 1,2,3-trifluorobenzene, 1,2,4-trifluorobenzene, 1,3,5-trifluorobenzene, 1,2,3,4-tetrafluorobenzene, 1,2,3,5-tetrafluorobenzene, 1,2,4,5-tetrafluorobenzene, pentafluorobenzene, hexafluorobenzene), halobenzene derivatives (e.g., 2-fluoroaniline, 3-fluoroaniline, 4-fluoroaniline, 2-fluoroanisole, 3-fluoroanisole, 4-fluoroanisole, 2-fluorobenzaldehyde, 3-fluorobenzaldehyde, 4-fluorobenzaldehyde, 2-fluorobenzonitriles, 3-fluorobenzonitriles, 4-fluorobenzonitriles, 2-fluoronitrobenzene, 3-fluoronitrobenzene, 4-fluoronitrobenzene, 2-fluorophenol, 3-fluorophenol, 4-fluorophenol, 2-fluorostyrene, 3-fluorostyrene, 4-fluorostyrene, 2-fluorotoluene, 3-fluorotoluene, 4-fluorotoluene, trifluorotoluene, etc.), fluoroalkanes (e.g., perfluorooctane, perfluoro-2-methylpentane, perfluoro-1,3-dimethylcyclohexane, perfluorodecalin, perfluoropentane, perfluoromethylcyclohexane, fluorocyclohexane, fluorocyclopropane, perfluorotripentylamine,1,1,2-trichloro-1,2,2-trifluoroethane, etc.), nonhalogenated solvents (e.g., anisole, ethoxybenzene, diphenyl ether, dibenzyl ether, furan, diethyl ether, 1,2-dimethoxyethane, diisopropyl ether, dibutyl ether, etc.), and/or other fluoroaromatic and/or fluoroaliphatic compounds (e.g., perfluorocompounds, monofluorocompounds, polyfluorocompounds, etc.). In some variants, other halogens can substitute or replace one or more fluorine atoms in fluorinated diluents (e.g., chlorine, bromine, and/or iodine can be used to substitute the fluorine in the above example diluent in these variants).

The salt(s) preferably function as an ion source within the electrolyte. However, the salt can additionally or alternatively act as a polymer plasticizer, and/or can otherwise function (e.g., function to form or improve properties of an SEI layer). The salt(s) are preferably highly concentrated within the salt-dissolving solvent (e.g., ≥3 M, ≥4 M, ≥5 M, ≥6 M, ≥7 M, ≥8 M, ≥9 M, ≥10 M, ≥12 M, ≥16 M, etc.). The salt(s) are preferably substantially insoluble in the diluent (e.g., less than about 1 gram of salt dissolves in about 1 litre of diluent). As a specific example, the salt is preferably at least 10 times more soluble in the salt-dissolving solvent than in the diluent. However, the salt(s) can have any suitable solubility in any components of the solvent mixture (e.g., in some variants, a plurality of salts can be used where one salt is soluble in the salt-dissolving solvent and one salt is soluble in the diluent). Examples of salt(s) include: lithium hexafluorophosphate (LiPF₆), lithium tetrafluoroarsenate (LiAsF₆), lithium perchlorate (LiClO₄), lithium tetrafluoroborate (LiBF₄), lithium triflate (LiCF₃SO₃), lithium tris(pentafluoroethyl)trifluorophosphate (LiFAP), lithium bis(fluorosulfonyl)imide (LiFSI), lithium-cyclo-difluoromethane-1,1-bis(sulfonyl)imide (LiDMSI), lithium-cyclo-hexafluoropropane-1,1-bis(sulfonyl)imide (LiHPSI), lithium bis(trifluorosulfonyl)imide (LiTFSI), lithium-cyclo-hexafluoropropane-1,1-bis(sulfonyl)imide (LiBETI), lithium bis(oxalate)borate (LiBOB), lithium difluoro (oxalato)borate (LiDFOB), lithium bis(monofluoromalonate)borate (LiBFMB), lithium tetracyanoborate (LiB(CN)₄), lithium 4,5-dicyano-1,2,3-triazolate (LiDCTA), lithium 2-trifluoromethyl-4,5-dicyanoimidazole (LiTDI), lithium 4,5-dicyano-2-(pentafluorylethyl)imidazole (LiPDI), sodium hexafluorophosphate (NaPF₆), sodium hexafluoroarsenate (NaAsF₆), sodium tetrafluoroborate (NaBF₄), sodium perchlorate (NaClO₄), sodium tetracyanoborate (NaB(CN)₄), sodium bis(fluorosulfonyl)imide (NaFSI), sodium bis(trifluorosulfonyl)imide (NaTFSI), sodium tris(trifluoromethanesulfonyl)methide (NaTFSM), sodium bis(oxalate)borate (NaBOB), sodium difluoro (oxalato)borate (NaDFOB), sodium fluoroalkylphoshpates, sodiumtris(pentafluoroethyl)trifluorophosphate), sodium-cyclo-difluoromethane-1,1-bis(sulfonyl)imide (NaDMSI), sodium-cyclo-hexafluoropropane-1,1-bis(sulfonyl)imide (NaHPSI), sodium-cyclo-hexafluoropropane-1,1-bis(sulfonyl)imide (NaBETI), sodium bis(monofluoromalonate)borate (NaBFMB), sodium 4,5-dicyano-1,2,3-triazolate (NaDCTA), sodium 2-trifluoromethyl-4,5-dicyanoimidazole (NaTDI), sodium 4,5-dicyano-2-(pentafluorylethyl)imidazole (NaPDI), sodium tris(pentafluoroethyl)trifluorophosphate (NaFAP), potassium hexafluorophosphate (KPF₆), potassium hexafluoroarsenate (KAsF₆), potassium tetrafluoroborate (KBF₄), potassium perchlorate (KClO₄), potassium tetracyanoborate (KB(CN)₄), potassium bis(fluorosulfonyl)imide (KFSI), potassium bis(trifluorosulfonyl)imide (KTFSI), potassium tris(trifluoromethanesulfonyl)methide (KTFSM), potassium bis(oxalate)borate (KBOB), potassium difluoro (oxalato)borate (KDFOB), potassium fluoroalkylphoshpates, potassium tris(pentafluoroethyl)trifluorophosphate), potassium-cyclo-difluoromethane-1,1-bis(sulfonyl)imide (KDMSI), potassium-cyclo-hexafluoropropane-1,1-bis(sulfonyl)imide (KHPSI), potassium-cyclo-hexafluoropropane-1,1-bis(sulfonyl)imide (KBETI), potassium bis(monofluoromalonato)borate (KBFMB), potassium 4,5-dicyano-1,2,3-triazolate (KDCTA), potassium 2-trifluoromethyl-4,5-dicyanoimidazole (KTDI), potassium 4,5-dicyano-2-(pentafluorylethyl)imidazole (KPDI), potassium tris(pentafluoroethyl)trifluorophosphate (KFAP), ammonium hexafluorophosphate, ammonium hexafluoroarsenate, ammonium tetrafluoroborate, ammonium perchlorate, ammonium tetracyanoborate, ammonium bis(fluorosulfonyl)imide, ammonium bis(trifluorosulfonyl)imide, ammonium tris(trifluoromethanesulfonyl)methide, ammonium bis(oxalate)borate, ammonium fluoroalkylphoshpates, ammonium tris(pentafluoroethyl)trifluorophosphate), ammonium-cyclo-difluoromethane-1,1-bis(sulfonyl)imide, ammonium-cyclo-hexafluoropropane-1,1-bis(sulfonyl)imide, ammonium-cyclo-hexafluoropropane-1,1-bis(sulfonyl)imide, ammonium difluoro (oxalato)borate, ammonium bis(monofluoromalonato)borate, ammonium 4,5-dicyano-1,2,3-triazolate, ammonium 2-trifluoromethyl-4,5-dicyanoimidazole, ammonium 4,5-dicyano-2-(pentafluorylethyl)imidazole, ammonium tris(pentafluoroethyl)trifluorophosphate, combinations thereof, and/or other suitable salt(s) can be used.

The polymer precursor preferably functions to (during curing) form a gel-electrolyte (e.g., freestanding polymer film; dispersion of solvent(s), salt(s), additive(s), etc. within a crosslinked polymer matrix; etc.). The polymer precursor is preferably dispersible and/or soluble in the solvent (e.g., both salt-dissolving solvent and diluent). In a specific example, the polymer precursor can have a higher solubility in the diluent than the salt-dissolving solvent which can be beneficial for minimizing salt displacement from the salt-dissolving solvent. However, the polymer precursor can be insoluble and/or poorly soluble in one or more component of the solvent (e.g., insoluble in the salt-dissolving solvent, insoluble in the diluent, etc.).

The polymer precursor can include one or more crosslinking monomers (e.g., monomers that include two or more polymerizable functional groups), one or more monofunctional monomers (e.g., monomers with a single polymerizable functional group), and/or any suitable components. The polymer precursor(s) are preferably terminated with an acrylate and/or methacrylate group (to facilitate polymer formation). However, the polymer precursor(s) can additionally or alternatively be terminated with a cyanoacrylate, imide, epoxy, thiol (e.g., for thiol-ene polymerization) group, and/or any suitable end group.

The polymer precursor is typically between about 1 and 20% (e.g., by mass, by volume, by stoichiometry, etc.) of the electrolyte composition. However, in some variants, a substantially solvent-free electrolyte can be formed (e.g., up to 90% of the electrolyte composition can be polymer or polymer precursor with the remainder being additives, salt, etc.). As a specific example, an electrolyte (before curing, treating, polymerization, etc.) can include about 60-80 wt % polymer precursor and 20-40 wt % other electrolyte components (e.g., solvent, salt, additives, etc.).

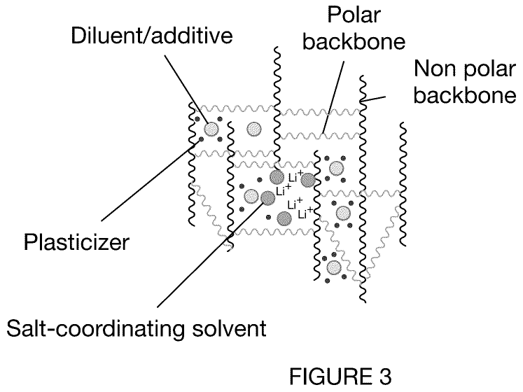

The crosslinking monomer(s) preferably function to form a cross-linked gel polymer matrix (that can enable ionic transport throughout the polymer). The crosslinking monomer are preferably difunctional monomers (e.g., feature polymerizable groups on two sites) which can facilitate and/or enable the formation of a crosslinked polymer network (upon polymerization such as to form a polymer as shown schematically in FIG. 3). However, polyfunctional monomers (e.g., tri-functional, tetra-functional, penta-functional, hexafunctional, octafunctional, deca-functional, etc.) can be used. In some variants, the crosslinking monomer can be an oligomer (e.g., made from two or more repeating subunits within the crosslinking monomer). The oligomer can be an alternating co-oligomer (e.g., A-B-A-B-A-B with monomers A and B), random co-oligomer, block co-oligomer (e.g., A-A-A-A-B-B-B-B for monomers A and B), graft co-oligomer, and/or can have any suitable structure.

The crosslinking monomer(s) preferably have non-polar groups (e.g., hydrocarbon, aliphatic, aromatic, etc. such as diethylene, triethylene, hexaethylene, etc.) linked by polar groups (e.g., carbonate, ester, ketone, carbamide, carbamate, thiocarbamate, thiocarbamide, thiocarbonate, dithiocarbonate, ether, thioether, imide, imine, epoxide, amide, acid anhydride, nitrile, amidine, cyanate, isocyanate, nitrosooxy, nitro, nitroso, oxime, sulfinyl, sulfonyl, sulfonate ester, sulfone, thiocyanate, isothiocyanate, thioester, dithiocarboxylic acid ester, etc.). In one specific example, the crosslinking monomer can include one or more hydrogen bond donors (e.g., Brønstead acid, Lewis acid, etc. such as ureido, urea, amidine, imidate, imide, alcohol, carboxylic acid, amine, etc.) and one or more hydrogen bond acceptors (Brønstead base, Lewis base, etc. such as ethers, esters, carbonates, amines, amides, imide, etc.). In variations of this specific example, the crosslinking monomers preferably include fewer hydrogen bond donor groups than hydrogen bond acceptor groups. In one such variation, a crosslinking monomer can include at most 2 hydrogen bond donors per polymerizable group (as other versions can result in a high viscosity that does not wet electrodes and/or separators effectively, as greater number of hydrogen bond donors can be difficult to introduce into the cell, etc.). However, any suitable crosslinking monomer(s) can be used.

The resulting crosslinked polymer network (formed by curing the polymer precursor) typically includes an aliphatic or nonpolar backbone (e.g., formed from reactions between acrylates and/or methacrylates) and a backbone that includes polar moieties (e.g., functional groups), where the polar moieties can facilitate interactions (e.g., ionic conductivity throughout the as-cured gel electrolyte) with the salt (and optionally the salt-dissolving solvent, additives, plasticizers, etc.). Note that while the backbone that includes polar moieties can be polar, the backbone with integral polar moieties can be aliphatic or largely nonpolar (e.g., depending on the aliphatic or aromatic regions or length connecting adjacent polar moieties). Relatedly, the resulting crosslinked polymer network can include polar and/or aliphatic pendant groups (e.g., from monofunctional polymer precursors).

Illustrative (and nonlimiting) examples of crosslinking monomers include: polyester urethane acrylates, polyester urethane methacrylates, polyether urethane acrylates, polycarbonate urethane acrylates, polycarbonate-polyether urethane acrylates, polycarbonate-polyester urethane acrylates, polyether-polyester urethane acrylates, polyimide urethane acrylates, polyester acrylates, epoxy acrylates, polycarbonate acrylates, polyester-polycarbonate acrylates, polyether acrylates, polyether-polyester acrylates, polyether-polycarbonate acrylates, polyether-polyester-polycarbonate (or other orderings thereof such as polyether-polycarbonate-polyester, polyester-polyether-polycarbonate, etc.) acrylates, aminated acrylates (e.g., aminated polyether acrylates, aminated urethane acrylates, aminated polyester urethane acrylates, aminated polycarbonate acrylates, combinations thereof, etc.), polycarbonate urethane methacrylates, polycarbonate-polyether urethane methacrylates, polycarbonate-polyester urethane methacrylates, polyether-polyester urethane methacrylates, polyimide urethane methacrylates, polyester methacrylates, epoxy methacrylates, polycarbonate methacrylates, polyester-polycarbonate methacrylates, polyether methacrylates, polyether-polyester methacrylates, polyether-polycarbonate methacrylates, polyether-polyester-polycarbonate (or other orderings thereof such as polyether-polycarbonate-polyester, polyester-polyether-polycarbonate, etc.) methacrylates, aminated methacrylates (e.g., aminated polyether methacrylates, aminated urethane methacrylates, aminated polyester methacrylates, aminated polycarbonate methacrylates, combinations thereof, etc.), polybutadiene urethane acrylates, polybutadiene urethane methacrylates, bisphenol A epoxy diacrylate, silicone urethane acrylate, thioether dendritic acrylates, thioether dendritic methacrylates, functional aliphatic polyether urethane acrylate, difunctional (e.g., diacrylate, diurethane, diurethane diacrylate) aromatic urethane acrylate, hydrophobic urethane acrylates (e.g., difunctional aliphatic hydrophobic urethane acrylate, aliphatic hydrophobic urethane acrylates, etc.), hydrophobic urethane acrylates (e.g., difunctional aliphatic hydrophobic urethane methacrylate, aliphatic hydrophobic urethane methacrylates, etc.), polycarbonate amidine acrylate, polyether amidine acrylate, polyester amidine acrylate, polycarbonate polyether amidine acrylate, polycarbonate polyester amidine acrylate, polyether polyester amidine acrylate, polycarbonate polyether polyester amidine acrylate, polyamidine acrylate, polycarbonate polyamidine acrylate, polyether polyamidine acrylate, polyester polyamidine acrylate, polycarbonate polyether polyamidine acrylate, polycarbonate polyester polyamidine acrylate, polyether polyester amidine acrylate, polycarbonate polyether polyester amidine acrylate, polycarbonate amidine methacrylate, polyether amidine methacrylate, polyester amidine methacrylate, polycarbonate polyether amidine methacrylate, polycarbonate polyester amidine methacrylate, polyether polyester amidine methacrylate, polycarbonate polyether polyester amidine methacrylate, polyamidine methacrylate, polycarbonate polyamidine methacrylate, polyether polyamidine methacrylate, polyester polyamidine methacrylate, polycarbonate polyether polyamidine methacrylate, polycarbonate polyester polyamidine methacrylate, polyether polyester amidine methacrylate, polycarbonate polyether polyester amidine methacrylate, polycarbonate imidate acrylate, polyether imidate acrylate, polyester imidate acrylate, polycarbonate polyether imidate acrylate, polycarbonate polyester imidate acrylate, polyether polyester imidate acrylate, polycarbonate polyether polyester imidate acrylate, polyimide acrylate, polycarbonate polyimide acrylate, polyether polyimide acrylate, polyester polyimide acrylate, polycarbonate polyether polyimide acrylate, polycarbonate polyester polyimide acrylate, polyether polyester imidate acrylate, polycarbonate polyether polyester imidate acrylate, polycarbonate imidate methacrylate, polyether imidate methacrylate, polyester imidate methacrylate, polycarbonate polyether imidate methacrylate, polycarbonate polyester imidate methacrylate, polyether polyester imidate methacrylate, polycarbonate polyether polyester imidate methacrylate, polyimide methacrylate, polycarbonate polyimide methacrylate, polyether polyimide methacrylate, polyester polyimide methacrylate, polycarbonate polyether polyimide methacrylate, polycarbonate polyester polyimide methacrylate, polyether polyester imidate methacrylate, polycarbonate polyether polyester imidate methacrylate, polycarbonate ureido acrylate, polyether ureido acrylate, polyester ureido acrylate, polycarbonate polyether ureido acrylate, polycarbonate polyester ureido acrylate, polyether polyester ureido acrylate, polycarbonate polyether polyester ureido acrylate, polyurea acrylate, polycarbonate polyurea acrylate, polyether polyurea acrylate, polyester polyurea acrylate, polycarbonate polyether polyurea acrylate, polycarbonate polyester polyurea acrylate, polyether polyester ureido acrylate, polycarbonate polyether polyester ureido acrylate, polycarbonate ureido methacrylate, polyether ureido methacrylate, polyester ureido methacrylate, polycarbonate polyether ureido methacrylate, polycarbonate polyester ureido methacrylate, polyether polyester ureido methacrylate, polycarbonate polyether polyester ureido methacrylate, polyurea methacrylate, polycarbonate polyurea methacrylate, polyether polyurea methacrylate, polyester polyurea methacrylate, polycarbonate polyether polyurea methacrylate, polycarbonate polyester polyurea methacrylate, polyether polyester ureido methacrylate, polycarbonate polyether polyester ureido methacrylate, polycarbonate urethane acrylate, polyether urethane acrylate, polyester urethane acrylate, polycarbonate polyether urethane acrylate, polycarbonate polyester urethane acrylate, polyether polyester urethane acrylate, polycarbonate polyether polyester urethane acrylate, polyurethane acrylate, polycarbonate polyurethane acrylate, polyether polyurethane acrylate, polyester polyurethane acrylate, polycarbonate polyether polyurethane acrylate, polycarbonate polyester polyurethane acrylate, polyether polyester urethane acrylate, polycarbonate polyether polyester urethane acrylate, polycarbonate urethane methacrylate, polyether urethane methacrylate, polyester urethane methacrylate, polycarbonate polyether urethane methacrylate, polycarbonate polyester urethane methacrylate, polyether polyester urethane methacrylate, polycarbonate polyether polyester urethane methacrylate, polyurethane methacrylate, polycarbonate polyurethane methacrylate, polyether polyurethane methacrylate, polyester polyurethane methacrylate, polycarbonate polyether polyurethane methacrylate, polycarbonate polyester polyurethane methacrylate, polyether polyester urethane methacrylate, polycarbonate polyether polyester urethane methacrylate, polycarbonate acrylate, polyether acrylate, polyester acrylate, polycarbonate polyether acrylate, polycarbonate polyester acrylate, polyether polyester acrylate, polycarbonate polyether polyester acrylate, polyether polyester acrylate, polycarbonate polyether polyester acrylate, polycarbonate methacrylate, polyether methacrylate, polyester methacrylate, polycarbonate polyether methacrylate, polycarbonate polyester methacrylate, polyether polyester methacrylate, polycarbonate polyether polyester methacrylate, polyether polyester methacrylate, and polycarbonate polyether polyester methacrylate, polysiloxane (silicone) urethane acrylates, polysiloxane (silicone) urethane methacrylates, diacrylates (e.g., polycaprolactone diacrylate, 1,4-butanediol diacrylate, poly(ethylene glycol) diacrylate such as with a Mw between 100 and 50000 Da, bisphenol A ethoxylate diacrylate, di(ethylene glycol) diacrylate, ethylene glycol diacrylate, 1,6-hexanediol diacrylate, poly(propylene glycol) diacrylate such as with a Mw between 100 and 50000 Da, 1,3-butanediol diacrylate, glycerol 1,3-diglycerolate diacrylate, tetra(ethylene glycol) diacrylate, neopentyl glycol diacrylate, tritolylamine diacrylate, tri (ethylene glycol) diacrylate, PEG-PPG diacrylate such as with a Mw between 100 and 50000 Da, PEG-PPG-PEG diacrylate such as with a Mw between 100 and 50000 Da, tricyclo[5.2.1.0^{2,6}]decanedimethanol diacrylate, fluorescein O,O′-diacrylate, bisphenol A glycerolate diacrylate, PCL-PEG-PCL diacrylate such as with a Mw between 100 and 50000 Da, tri (propylene glycol) diacrylate, trimethylolpropane ethoxylate methyl ether diacrylate, 9-(acryloyloxy) nonyl acrylate, bis[2-(acryloyloxy)ethyl]phosphate etc.), dimethacrylates (e.g., polycaprolactone dimethacrylate, 1,4-butanediol dimethacrylate, poly(ethylene glycol) dimethacrylate such as with a Mw between 100 and 50000 Da, bisphenol A ethoxylate dimethacrylate, di(ethylene glycol) dimethacrylate, ethylene glycol dimethacrylate, 1,6-hexanediol dimethacrylate, poly(propylene glycol) dimethacrylate such as with a Mw between 100 and 50000 Da, 1,3-butanediol dimethacrylate, glycerol 1,3-diglycerolate dimethacrylate, tetra(ethylene glycol) dimethacrylate, neopentyl glycol dimethacrylate, tritolylamine dimethacrylate, tri (ethylene glycol) dimethacrylate, PEG-PPG dimethacrylate such as with a Mw between 100 and 50000 Da, PEG-PPG-PEG dimethacrylate such as with a Mw between 100 and 50000 Da, tricyclo[5.2.1.0^{2,6}]decanedimethanol dimethacrylate, fluorescein O,O′-dimethacrylate, bisphenol A glycerolate dimethacrylate, PCL-PEG-PCL dimethacrylate such as with a Mw between 100 and 50000 Da, tri (propylene glycol) dimethacrylate, trimethylolpropane ethoxylate methyl ether dimethacrylate, 9-(acryloyloxy) nonyl dimethacrylate, Bis[2-(methacryloyloxy)ethyl]phosphate, etc.), triacrylates (e.g., trimethylolpropane ethoxylate triacrylate, trimethylolpropane triacrylate, trimethylolpropane propoxylate triacrylate, glycerol propoxylate triacrylate, pentaerythritol triacrylate, zirconium bromonorbornanelactone carboxylate triacrylate, tris[2-(acryloyloxy)ethyl]isocyanurate, tris[2-(acryloyloxy)ethyl]phosphate, etc.), trimethacrylates (e.g., trimethylolpropane ethoxylate trimethacrylate, trimethylolpropane trimethacrylate, trimethylolpropane propoxylate trimethacrylate, glycerol propoxylate trimethacrylate, pentaerythritol trimethacrylate, zirconium bromonorbornanelactone carboxylate trimethacrylate, tris[2-(methacryloyloxy)ethyl]isocyanurate, tris[2-(methacryloyloxy)ethyl]phosphate, etc.), tetraacrylates (e.g., pentaerythritol tetraacrylate, 3-(N,N,N,N tetrakis(propionate) hexanediamino)-2-hydroxypropyl acrylate, etc.), tetramethacrylates (e.g., pentaerythritol tetramethacrylate, 3-(N,N,N,N tetrakis(propionate) hexanediamino)-2-hydroxypropyl methacrylate, etc.), pentaacrylate (e.g., dipentaerythritol pentaacrylate), pentamethacrylate (e.g., dipentaerythritol pentaacrylate), hexaacrylates (e.g., dipentaerythritol hexaacrylate), hexamethacrylates (e.g., dipentaerythritol hexamethacrylate), silsesquioxane acrylates, polyhedral oligomeric silsesquioxane (POSS) acrylates, silsesquioxane methacrylates, POSS methacrylates, poly(ethylene glycol) diacrylate, trimethylolpropane triacrylate (TMPTA), trimethylolpropane trimethacrylate (TMPTMA), tripropylene glycol diacrylate (TPGDA), 1,6-hexanediol diacrylate (HDDA), ethylene glycol diacrylate, ethylene glycol dimethacrylate, diethylene glycol diacrylate, diethylene glycol dimethacrylate, triethylene glycol diacrylate, triethylene glycol dimethacrylate, tetraethylene glycol diacrylate, tetraethylene glycol dimethacrylate, pentaethylene glycol diacrylate, pentaethylene glycol dimethacrylate, polyethylene glycol diacrylate, polyethylene glycol dimethacrylate, ethylene glycol methyl ether diacrylate, ethylene glycol methyl ether dimethacrylate, and/or other suitable crosslinking monomers can be used.

As an illustrative example, a crosslinking monomer can have the form

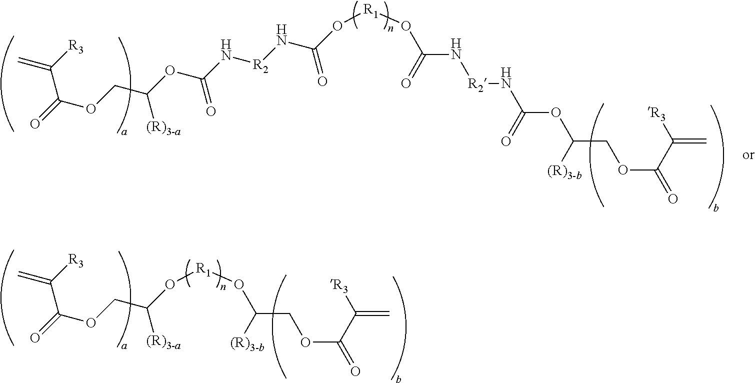

where R1 can be selected from:

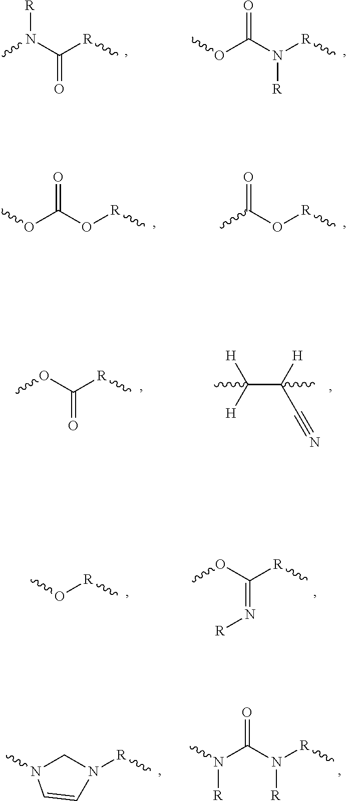

or combinations thereof; where R2 and R2′ are each independently selected from the group consisting of:

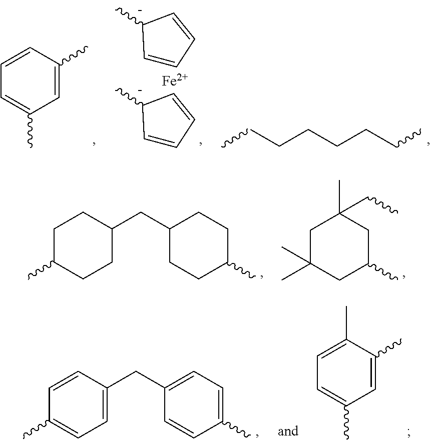

where R3 and R3′ are each independently selected from hydrogen, methyl, and ethyl; and where each R is independently selected from: a substituted or unsubstituted alkylene group having 1 to 40 carbon atoms, a substituted or unsubstituted cycloalkylene group having 4 to 40 carbon atoms, and a substituted or unsubstituted arylene group having 6 to 40 carbon atoms; where n is the number of repeat or individual monomer units, where n is a value between 1 and 1000; and where a and b are each independently between 0 and 3, where at least one of a or b is not 0. In some variations, a plurality of crosslinking monomers can be used (e.g., with different R1 selections, with different R1 distributions, etc.). In these variations, one crosslinking monomer can act as an adhesion promoter and the second crosslinking monomer can act as the primary electrolyte (e.g., contributing to a majority of the properties of the electrolyte pre- and/or post-curing properties). For instance, the crosslinking monomers portion of the polymer electrolyte composition could include about 1-20% (by mass, by volume, by stoichiometry, etc.) of the first crosslinking monomer and about 80-99% (by mass, by volume, by stoichiometry, etc.) of the second crosslinking monomer.

The monofunctional monomer(s) can function to tune a property of the polymer matrix. Examples of properties include cross-linking density, ionic conductivity, adhesion (e.g., to a current collector, electrode, separator, etc.), electronic conductivity, stability, density, stiffness, flammability, reactivity, and/or other suitable properties. In one embodiment, an average free polymerizable groups per molecule of the polymer precursor can be at most about 2 (e.g., 2.1, 2.05, 1.99, 1.98, 1.95, 1.9, 1.85, 1.8, 1.75, 1.7, 1.5, etc.). Examples of monomers include: isobornyl acrylate (IBOA), isobornyl methacrylate (IBOMA), methyl methacrylate, methyl acrylate, ethyl methacrylate, ethyl acrylate, propyl methacrylate, propyl methacrylate, butyl acrylate, butyl methacrylate, isobutyl acrylate, isobutyl methacrylate, ethylene glycol monoacrylate, ethylene glycol monomethacrylate, diethylene glycol monoacrylate, diethylene glycol monomethacrylate, triethylene glycol monoacrylate, triethylene glycol monomethacrylate, tetraethylene glycol monoacrylate, tetraethylene glycol monomethacrylate, pentaethylene glycol monoacrylate, pentaethylene glycol monomethacrylate, polyethylene glycol monoacrylate, polyethylene glycol monomethacrylate, poly(ethylene glycol) methyl ether methacrylate, (hydroxyethyl) methacrylate (HEMA), fluorinated acrylates (e.g., pentafluorophenyl acrylate, 2,2,2-trifluoroethyl acrylate, 1H,1H,2H,2H-heptadecafluorodecyl acrylate, 1H,1H,5H-octafluoropentyl acrylate, 2,2,3,4,4,4-hexafluorobutyl acrylate, 1,1,1,3,3,3-hexafluoroisopropyl acrylate, 2,2,3,3,4,4,4-heptafluorobutyl acrylate, methyl 2-fluoroacrylate, 1H,1H,2H,2H-nonafluorohexyl acrylate, 2,2,3,3,3-pentafluoropropyl acrylate, 2,2,3,3-tetrafluoropropyl acrylate, 1H,1H,2H,2H-tridecafluoro-n-octyl acrylate, 2-(trifluoromethyl) acrylic acid, 2,2,3,3,4,4,5,5,6,6,7,7-dodecafluoroheptyl acrylate, 1H,1H,-pentadecafluoro-n-octyl acrylate, etc.), fluorinated methacrylates (e.g., pentafluorophenyl methacrylate, 2,2,2-trifluoroethyl methacrylate, 1H,1H,2H,2H-heptadecafluorodecyl methacrylate, 1H,1H,5H-octafluoropentyl methacrylate, 2,2,3,4,4,4-hexafluorobutyl methacrylate, 1,1,1,3,3,3-hexafluoroisopropyl methacrylate, 2,2,3,3,4,4,4-heptafluorobutyl methacrylate, 1H,1H,2H,2H-nonafluorohexyl methacrylate, 2,2,3,3,3-pentafluoropropyl methacrylate, 2,2,3,3-tetrafluoropropyl methacrylate, 1H,1H,2H,2H-tridecafluoro-n-octyl methacrylate, 2-(trifluoromethyl) methacrylic acid, 2,2,3,3,4,4,5,5,6,6,7,7-dodecafluoroheptyl methacrylate, 1H,1H,-pentadecafluoro-n-octyl acrylate, etc.), phosphate acrylates and/or methacrylates (e.g., phosphoric acid 2-hydroxyethyl methacrylate ester, bis[2-(methacryloyloxy)ethyl]phosphate, 2-hydroxyethyl acrylate phosphate, (hydroxyethyl) methacrylate phosphate (HEMA-P), etc.), methyl acrylate, benzyl acrylate, dodecyl acrylate, 2-ethoxyethyl acrylate, ethyl acrylate, butyl acrylate, sec-butyl acrylate, 2-ethylhexyl acrylate, hexyl acrylate, 2-cyanoethyl acrylate, cyclohexyl acrylate, isobutyl acrylate, isopropyl acrylate, 2-methoxyethyl acrylate, methyl acrylate, 2,2,2-trifluoroethyl acrylate, dimethylaminoethyl methacrylate, dodecyl methacrylate, 2-tert-butylaminoethyl methacrylate, n-butyl methacrylate, 2-ethylhexyl methacrylate, hexadecyl methacrylate, hexyl methacrylate, 2-hydropropyl methacrylate, 2-hydroxyethyl methacrylate, diethylaminoethyl methacrylate, octadecyl methacrylate, octyl methacrylate, 2-octyl cyanoacrylate, n-decyl cyanoacrylate, 2-methylstyrene, isobornyl acrylate, hexadecyl acrylate, t-butyl acrylate, methacrylic acid, styrene, methylstyrene, dimethylstyrene, trimethylstyrene, t-butyl styrene; halostyrenes, ethoxystyrene, acetoxystyrene, methyl methacrylate, benzyl methacrylate, ethyl methacrylate, isopropyl methacrylate, hydropropyl methacrylate, isobutyl methacrylate, t-butyl methacrylate, cyclohexyl methacrylate, isobornyl methacrylate, phenyl methacrylate, trimethylsilyl methacrylate, stiffening and/or compliant monomers (e.g., as described in U.S. patent application Ser. No. 18/928,887 titled ‘SYSTEM AND METHOD FOR IMPROVED BATTERY STRUCTURAL PROPERTIES, filed 28 Oct. 2024 which is incorporated in its entirety by this reference), and/or other suitable monomers can be used.

The additives can function to control one or more property of the electrochemical cell (e.g., battery) and/or component thereof (e.g., electrode, separator, electrolyte, etc.). The additives (e.g., total additive concentration, concentration for each individual additive, etc.) are typically included at a concentration between about 1 and 20% (e.g., by weight, by volume, by stoichiometry, etc.) of the electrolyte. The additive(s) can include: inhibitors, initiators, plasticizers, electrochemical additives (e.g., SEI-forming additives, safety additives, etc.), and/or any suitable additives.

The initiator can function to start and/or control the polymerization (e.g., rate of polymerization, timing of polymerization, extent of crosslinking, etc.). The initiator is preferably a thermal initiator (e.g., initiates the polymerization reaction above a threshold temperature). However, the initiator can additionally or alternatively be an electrochemical initiator, optical initiator, mechanical initiator, and/or any suitable initiator. Examples of initiators include 2,2′-azobisisobutyronitrile (AIBN), dimethyl 2,2′-azobis(2-methylpropionate) (AIBME), 2,2′-azobis(2-methylbutanenitrile) (AMBN), 2,2′-azobis(2,4-dimethylvaleronitrile) (ADVN), 1,3-adamantanedicarboxylic acid (ADA), 2,2-bis(tert-butylperoxy)butane, 1,1-bis(tert-butylperoxy)cyclohexane, 2,2′-azobis[2-(2-imidazolin-2-yl)-propane]dihydrochloride, 2,5-bis(tert-butylperoxy)-2,5-dimethylhexane, 2,5-bis(tert-butylperoxy)-2,5-dimethyl-3-hexyne, bis(1-(tertbutylperoxy)-1-methylethyl)benzene, 1,1-bis(tert-butylperoxy)-3,3,5-trimethylcyclohexane, tert-butyl peracetate, tert-butyl hydroperoxide (TBHP), cumene hydroperoxide, di-tert-butyl peroxide, tert-butyl peroxybenzoate, tert-butylperoxyisopropyl carbonate, dicumyl peroxide, benzoyl peroxide, lauroyl peroxide, 2,4-pentanedione peroxide, peracetic acid, tert-amyl peroxybenzoate, 4,4-azobis(4-cyanovaleric acid), 1,1′-azobis(cyclohexanecarbonitrile) (ABCN or ACHN), ammonium persulfate, sodium persulfate, potassium persulfate (or other persulfate salts), and/or any suitable initiator can be used. The concentration of initiator is typically between about 0.1% about 10% (e.g., wt % such as 0.1%, 0.2%, 0.3%, 0.5%, 1%, 2%, 2.5%, 3%, 5%, 7%, 7.5%, 9%, 10%, values or ranges therebetween, etc.) relative to the polymer precursor.

The inhibitor can function to control the polymerization (e.g., rate of polymerization, timing of polymerization, extent of crosslinking, etc.). Examples of inhibitors include 4-methoxyphenol (MEHQ), monobenzone, hydroquinone, guaiacol, 2-hydroxy-5-methoxybenzaldehyde, 1,2-benzoquinone, 1,4-benzoquinone, 1,4-naphthoquinone, 9,10-anthraquinone, chloranil, quinone methide, p-phenylenediamines, phenothiazine, diethylhydroxylamine, hydroxylhydroxylamine, (2,2,6,6-Tetramethylpiperidin-1-yl)oxyl (TEMPO), 4-hydroxy-TEMPO (TEMPOL), and/or any suitable inhibitor(s) can be used. The concentration of inhibitor is typically less than about 1% (e.g., wt % such as 1 ppb, 10 ppb, 100 ppb, 1 ppm, 10 ppm, 100 ppm, 1000 ppm, values or ranges therebetween) relative to the polymer precursor(s).

The plasticizer can function to modify the softness and/or flexibility of the gel electrolyte (e.g., the as cured polymer electrolyte), the viscosity of the electrolyte (e.g., prior to curing, subsequent to curing, etc.), decrease friction during handling the electrolyte, act as a surfactant and/or emulsifier (e.g., polarity bridge) between solvents (e.g., between nonpolar and polar solvents, reducing and/or preventing phase separation of the different components of the electrolyte or electrolyte precursor) and/or polymer precursors (e.g., polymer precursors and nonpolar solvent, polymer precursor and polar solvent, etc.), and/or can otherwise function. In some variations, the salt and/or solvent can function as plasticizers (and/or additional solvent and/or salt can be added to perform the function of the plasticizer). Examples of plasticizers include: PC, FEC, EC, FEC, TMP, TEP, PFPN, fluoropolymers (e.g., Zonyl, lithium-3-[(1H,1H,2H,2H-fluoroalkyl)thio]-propionate, semi-fluorinated acryl polymer EGC-1700, fluoromethacrylate, long-chain perfluoroacrylates, tetrafluorethylene, hexafluoropropylene, silane-coupling agent with perfluoropolyether (PFPE-S), (perfluoroalkyl)ethyl methacrylate-containing acrylic polymers, butyl methacrylate-co-perfluoroalkyl acrylate, semifluorinated fluorocarbon diblock copolymer poly(butyl methacrylate-co-perfluoroalkyl acrylate), n-perfluorononane, perfluoropropyleneoxyde, polytetrafluoroethylene, poly(tetrafluoroethylene-co-hexafluoropropylene), perfluorobutyl (PFB), perfluoromethyl, perfluoroethyl, etc.), fluorosurfactants (e.g., perfluorosulfonic acids such as perfluorooctanesulfonic acid (PFOS), perfluorocarboxylic acids such as perfluorooctanoic acid (PFOA) or perfluorononanoic acid (PFNA), Zonyl SFK, Zonyl SF-62, FLURAD FC170, FLURAD FC123, FLURAD L-18699A, Novec F-C4300, 3 M FC-4430, Novec 3 M FC-4432, 3 M FC-4434, etc.), and/or other suitable plasticizer(s) or surfactant(s) can be included.

In variants where the same material is serving multiple functions (e.g., acting as an electrode additive and a plasticizer), the total composition of each can be cumulative. For instance, when FEC is used as an additive (e.g., 1-20 wt %) and a plasticizer (e.g., 1-5 wt %), the total amount of FEC can be between 2 and 25% by weight of the total electrolyte composition. In other variants where the same material is serving multiple functions (e.g., acting as an electrode additive and a plasticizer), the total composition can be bounded by the greatest and least extent of material. For instance, when FEC is used as an additive (e.g., 1-20 wt %) and a plasticizer (e.g., 1-5 wt %), the total amount of FEC can be between 1 and 20% by weight of the total electrolyte composition. However, the same material performing multiple functions can otherwise be accommodated.

The cell additive(s) can function improve a viscosity (e.g., lower viscosity), wettability (e.g., increase wettability), stability (e.g., increase a lifetime), cycling performance (e.g., SEI formation, SEI stability, SEI ductility, etc.), reduce a flammability of, and/or otherwise can be included in the electrolyte. Examples of cell additives include: fluoroethylene carbonate (FEC), trivinylcyclotriboroxane (tVCBO), vinylene carbonate (VC), sulfone, 1,3,2-Dioxathiolan-2,2-oxide (DTD), ethyl methyl sulfone, tetramethyl sulfone (TMS), prop-1-ene-1,3-sulfone (PES), 1,3-propane sultone (PS), 1,4-butane sultone, propenyl-1,3-sultone, cyclic sulfate, dioxolane, 5-methyl-4-((trifluoromethoxy)methyl)-1,3-dioxol-2-one, phenyl boronic acid glycol ester (PBE), 5-methyl-4-((trimethylsilyloxy)methyl)-1,3-dioxol-2-one, trimethylphosphate (TMP), triethylphosphate (TEP), tributylphosphate (TBP), triphenylphosphate (TPP), tris(2,2,2-trifluoroethyl)phosphate (TFP), methyl P,P-bis(2,2,2-trifluoroethyl)phosphate (BMP), trimethylphosphite (TMPi), tris(2,2,2-trifluoroethyl)phosphite (TTFPi), dimethyl methyl phosphate (DMMP), diethyl ethylphosphate (DEEP), bis(2,2,2-trifluoroethyl)methylphosphate (TFMP), bis(2,2,2-trifluoroethyl)ethylphosphate (TFEP), hexa(methoxy)cyclotriphosphazene (HMOCPN), (ethoxy)pentafluorocyclotriphosphazene (PFPN), (phenoxy)pentafluorocyclotriphosphazene (FPPN), tris(trimethylsilyl)phosphite (TMSPi), Phoslyte™, nitriles (e.g., succinonitrile (SN), malononitrile, glutaronitrile, adiponitrile (ADN), 1,1-bis(20cyanoethoxy) ethane, 1,1-dicyano-2-butene, hexane-1,3,6-tricarbonitrile, 1,2,3-tris(2-cyanoethoxy) propane, acetonitrile, benzonitrile, phthalonitrile, isobutyronitrile, cyanoform, etc.), silanes (e.g., dimethoxydimethylsilane, methyltrimethoxysilane, tetramethoxysilane, dimethylethoxysilane, triethylsilyl fluoromethanesulfonate, ethyltriacetoxysilane, Diphenylmethoxysilane, difluorodiphenylsilane, etc.), and/or other suitable cell additives can be used.

The electrolyte (e.g., polymer precursor thereof) is preferably cured (e.g., to form a gel-polymer) in situ (for instance using thermal energy, optical energy, electrochemical energy, in a manner as described in U.S. patent application Ser. No. 18/443,716 titled ‘GEL ELECTROLYTE COMPOSITION FOR A BATTERY AND A METHOD OF IMPLEMENTATION’ filed 16 Feb. 2024 which is incorporated in its entirety by this reference, etc.). However, the electrolyte can be cured in any manner (e.g., ex situ where the cured polymer can be transferred to a battery).

Embodiments of the system and/or method can include every combination and permutation of the various system components and the various method processes, wherein one or more instances of the method and/or processes described herein can be performed asynchronously (e.g., sequentially), contemporaneously (e.g., concurrently, in parallel, etc.), or in any other suitable order by and/or using one or more instances of the systems, elements, and/or entities described herein. Components and/or processes of the preceding system and/or method can be used with, in addition to, in lieu of, or otherwise integrated with all or a portion of the systems and/or methods disclosed in the applications mentioned above, each of which are incorporated in their entirety by this reference.

As used herein, “substantially” or other words of approximation (e.g., “about,” “approximately,” etc.) can be within a predetermined error threshold or tolerance of a metric, component, or other reference (e.g., within 0.001%, 0.01%, 0.1%, 1%, 5%, 10%, 20%, 30% of a reference), or be otherwise interpreted.

As a person skilled in the art will recognize from the previous detailed description and from the figures and claims, modifications and changes can be made to the preferred embodiments of the invention without departing from the scope of this invention defined in the following claims.

### Specific Examples

A numbered list of specific examples of the technology described herein are provided below. A person of skill in the art will recognize that the scope of the technology is not limited to and/or by these specific examples.

1. A method for forming a battery cell comprising: wetting an anode, a cathode, and a separator with a polymer precursor solution, wherein the polymer precursor solution comprises: a salt; an ionic liquid, wherein the salt is dissolved in the ionic liquid; a diluent, wherein a solubility of the salt in the diluent is at most one tenth that of the solubility of the salt in the ionic liquid; and a polymer precursor comprising at least one multifunctional cross-linking monomer (e.g., diacrylates or dimethacrylates), wherein the polymer precursor is dissolved in the ionic liquid and the diluent; sealing the battery cell; and curing the polymer precursor to form a gel electrolyte throughout the anode, the cathode, and the separator.

2. The method of specific example 1, wherein the polymer precursor solution further comprises an initiator selected from the group consisting of: dimethyl 2,2′-azobis(2-methylpropionate, 2,2′-azobis(2,4-dimethyl-4-methoxyvaleronitrile), 1,1′-azobis(cyclohexanecarbonitrile) (ACHN), azobisisobutylonitrile (AIBN), 1,1′-azobis-1,2,3-triazole, 2,2′-azobis(2,4-dimethylvaleronitrile), 2,2-azobis(2-methylbutyronitrile), 2,2′-azobis(N-butyl-2-methyl propionamide), 2,2′-azobis(2,4,5-trimethylpentane), 2,2′-azobis[2-(2-imidazolin-2-yl) propane]dihydrochloride, di-tert-butyl peroxide, benzoyl peroxide, methyl ethyl ketone peroxide, acetone peroxide, tert-butyl hydroperoxide, cumene hydroperoxide, dicumyl peroxide, ammonium persulfate, and combinations thereof; wherein curing the polymer precursor comprises thermally forming free radicals from the initiator.

3 The method of any of specific examples 1-2, wherein the polymer precursor solution further comprises a plasticizer, wherein the salt is further dissolved in the plasticizer.

4. The method of specific example 3, wherein the plasticizer is selected from the group consisting of: ethylene carbonate (EC), propylene carbonate (PC), fluoroethylene carbonate (FEC), triglyme, tetraglyme, methyl propionate (MP), methyl butanoate (MB), ethyl propionate (EP), ethyl butanoate (EB), propyl propionate (PP), ethylene sulfite, sulfolane, trimethylphosphate (TMP), triethylphosphate (TEP), tributylphosphate (TBP), triphenylphosphate (TPP), dimethyl methyl phosphate (DMMP), diethyl ethylphosphate (DEEP), trimethylphosphite (TMPi), triethylphosphite (TEPi), phosphazenes, fluorosurfactants, γ-butyrolactone (GBL), dimethylacetamide (DMAc), N-methyl-2-pyrrolidone (NMP), and combinations thereof.

5. The method of any of specific examples 1-4, wherein the diluent is selected from the group comprising: (ethoxy)pentafluorocyclotriphosphazene (PFPN), (phenoxy)pentafluorocyclotriphosphazene (FPPN), tris(2,2,2-trifluoroethyl)phosphate (TFP), bis(2,2,2-trifluoroethyl)methylphosphate (TFMP), bis(2,2,2-trifluoroethyl)ethylphosphate (TFEP), tris(2,2,2-trifluoroethyl)borate (TTFEB), tris(2,2,2-trifluoroethyl)phosphite (TTFPi), methyl 3,3,3-trifluoropropanoate (MTFP), ethyl trifluoroacetate (ETFA), 2,2,2-trifluoroethylacetate (TFEA), methyl pentafluoropropionate (MPFP), ethyl 3,3,3-trifluoropyruvate tris(2-fluoroethyl)borate (TFEB), methyl 2,2,2-trifluoroethyl carbonate (MTFEC), ethyl 2,2,2-trifluoroethyl carbonate (ETFEC), propyl 2,2,2-trifluoroethyl carbonate (PTFEC), methyl 2,2,2,2′,2′,2′-hexafluoro-isopropyl carbonate (MHFPC), ethyl 2,2,2,2′,2′,2′-hexafluoro-isopropyl carbonate (EHFPC), di-2,2,2-trifluoroethyl carbonate (DTFEC), trifluoropropylene carbonate (TFPC), trifluorobutylene carbonate (TFBC), difluorovinyl carbonate (DFVC), trifluoroethyl methyl carbonate (TFEMC), bis(2,2,2-trifluoroethyl) carbonate (DFDEC), bis(2,2,2-trifluoroethyl) ether (BTFE), 1,1,2,2-tetrafluoroethyl 2,2,2 trifluoroethyl ether, ethyl nonafluorobutyl ether, methyl decafluoro-2-methoxy-4 (trifluoromethyl)pentane, ethyl 1,1,2,2-tetrafluoroethyl ether, ethyl 1,1,2,3,3,3-hexafluoropropyl ether, fluoromethyl 1,1,1,3,3,3-hexafluoroisopropyl ether, 1,1,2,3,3,3-hexafluoropropyl methyl ether, hexafluoroisopropyl methyl ether, methyl 2,2,3,3,3-pentafluoropropyl ether, methyl 1,1,2,2-tetrafluoroethyl ether, 1H,1H,5H-octafluoropentyl 1,1,2,2-tetrafluoroethyl ether, 3,3,4,4-tetrafluorotetrahydrofuran, 1,1,2,2-tetrafluoroethyl-2,2,3,3-tetrafluoropropyl ether (TTE), 2,2-dimethoxy-4-(trifluoromethyl)-1,3-dioxolane (DTDL), tris(2,2,2-trifluoroethyl)orthoformate (TFEO), hexafluoropropylene oxide, perfluoroether (PFE), hydrofluorethers (HFE), monofluorobenzene, 1,2-difluorobenzene, 1,3-difluorobenzene, 1,4-difluorobenzene, 1,2,3-trifluorobenzene, 1,2,4-trifluorobenzene, 1,3,5-trifluorobenzene, 1,2,3,4-tetrafluorobenzene, 1,2,3,5-tetrafluorobenzene, 1,2,4,5-tetrafluorobenzene, pentafluorobenzene, hexafluorobenzene, 2-fluorobenzaldehyde, 3-fluorobenzaldehyde, 4-fluorobenzaldehyde, 2-fluorobenzonitriles, 3-fluorobenzonitriles, 4-fluorobenzonitriles, 2-fluorostyrene, 3-fluorostyrene, 4-fluorostyrene, 2-fluorotoluene, 3-fluorotoluene, 4-fluorotoluene, trifluorotoluene, perfluorooctane, perfluoro-2-methylpentane, perfluoro-1,3-dimethylcyclohexane, perfluorodecalin, perfluoropentane, perfluoromethylcyclohexane, fluorocyclohexane, fluorocyclopropane, perfluorotripentylamine,1,1,2-trichloro-1,2,2-trifluoroethane, and combinations thereof.

6. The method of any of specific examples 1-5, wherein a cation of the ionic liquid is selected from the group consisting of: 1-alkyl-3-methyl imidazolium, N-alkyl pyridinium, N-alkyl-N-methyl piperidinium, tetraalkyl-ammonium, tetraalkyl phosphonium, N-alkyl-N-methyl 1,2-dialkyl-pyrazolium, N-alkyl-thiazolium, trialkylsulfonium, and combinations thereof; and wherein an anion of the ionic liquid is selected from the group consisting of: from hexafluorophosphate, tetrafluoroarsenate, perchlorate, tetrafluoroborate, triflate, chloride, bromide, iodide, tris(pentafluoroethyl)trifluorophosphate, bis(fluorosulfonyl)imide, cyclo-difluoromethane-1,1-bis(sulfonyl)imide, cyclo-hexafluoropropane-1,1-bis(sulfonyl)imide, bis(trifluorosulfonyl)imide, cyclo-hexafluoropropane-1,1-bis(sulfonyl)imide, bis(oxalate)borate, difluoro (oxalato)borate, bis(monofluoromalonato)borate, tetracyanoborate, 4,5-dicyano-1,2,3-triazolate, 2-trifluoromethyl-4,5-dicyanoimidazole, 4,5-dicyano-2-(pentafluorylethyl)imidazole, and combinations thereof; wherein each alkyl group can be independently selected from methyl, ethyl, propyl, butyl, pentyl, hexyl, heptyl, octyl, nonyl, decyl, undecyl, dodecyl, aryl, naphthyl group or variations of the preceding with one or more hydrogen atom replaced with a fluorine atom.

7. A prepolymer electrolyte composition comprising: a salt; a polar solvent, wherein the salt is dissolved in the polar solvent to a concentration between 10 and 60 wt %; a diluent, wherein a solubility of the salt in the diluent is at most one tenth that of the solubility of the salt in the polar solvent; and a polymer precursor mixture comprising at least one multifunctional cross-linking monomer (e.g., diacrylates or dimethacrylates).

8. The prepolymer electrolyte composition of specific example 7, wherein the polar solvent is selected from: ethylene carbonate (EC), propylene carbonate (PC), fluoroethylene carbonate (FEC), triglyme, tetraglyme, methyl propionate (MP), methyl butanoate (MB), ethyl propionate (EP), ethyl butanoate (EB), propyl propionate (PP), ethylene sulfite, sulfolane, trimethylphosphate (TMP), triethylphosphate (TEP), tributylphosphate (TBP), triphenylphosphate (TPP), dimethyl methyl phosphate (DMMP), diethyl ethylphosphate (DEEP), trimethylphosphite (TMPi), triethylphosphite (TEPi), phosphazenes, or combinations thereof.

9. The prepolymer electrolyte composition of any of specific examples 7-8, wherein the diluent is selected from: (ethoxy)pentafluorocyclotriphosphazene (PFPN), (phenoxy)pentafluorocyclotriphosphazene (FPPN), tris(2,2,2-trifluoroethyl)phosphate (TFP), bis(2,2,2-trifluoroethyl)methylphosphate (TFMP), bis(2,2,2-trifluoroethyl)ethylphosphate (TFEP), tris(2,2,2-trifluoroethyl)borate (TTFEB), tris(2,2,2-trifluoroethyl)phosphite (TTFPi), methyl 3,3,3-trifluoropropanoate (MTFP), ethyl trifluoroacetate (ETFA), 2,2,2-trifluoroethylacetate (TFEA), methyl pentafluoropropionate (MPFP), ethyl 3,3,3-trifluoropyruvate tris(2-fluoroethyl)borate (TFEB), methyl 2,2,2-trifluoroethyl carbonate (MTFEC), ethyl 2,2,2-trifluoroethyl carbonate (ETFEC), propyl 2,2,2-trifluoroethyl carbonate (PTFEC), methyl 2,2,2,2′,2′,2′-hexafluoro-isopropyl carbonate (MHFPC), ethyl 2,2,2,2′,2′,2′-hexafluoro-isopropyl carbonate (EHFPC), di-2,2,2-trifluoroethyl carbonate (DTFEC), trifluoropropylene carbonate (TFPC), trifluorobutylene carbonate (TFBC), difluorovinyl carbonate (DFVC), trifluoroethyl methyl carbonate (TFEMC), bis(2,2,2-trifluoroethyl) carbonate (DFDEC), bis(2,2,2-trifluoroethyl) ether (BTFE), 1,1,2,2-tetrafluoroethyl 2,2,2 trifluoroethyl ether, ethyl nonafluorobutyl ether, methyl decafluoro-2-methoxy-4 (trifluoromethyl)pentane, ethyl 1,1,2,2-tetrafluoroethyl ether, ethyl 1,1,2,3,3,3-hexafluoropropyl ether, fluoromethyl 1,1,1,3,3,3-hexafluoroisopropyl ether, 1,1,2,3,3,3-hexafluoropropyl methyl ether, hexafluoroisopropyl methyl ether, methyl 2,2,3,3,3-pentafluoropropyl ether, methyl 1,1,2,2-tetrafluoroethyl ether, 1H,1H,5H-octafluoropentyl 1,1,2,2-tetrafluoroethyl ether, 3,3,4,4-tetrafluorotetrahydrofuran, 1,1,2,2-tetrafluoroethyl-2,2,3,3-tetrafluoropropyl ether (TTE), 2,2-dimethoxy-4-(trifluoromethyl)-1,3-dioxolane (DTDL), tris(2,2,2-trifluoroethyl)orthoformate (TFEO), hexafluoropropylene oxide, perfluoroether (PFE), hydrofluorethers (HFE), monofluorobenzene, 1,2-difluorobenzene, 1,3-difluorobenzene, 1,4-difluorobenzene, 1,2,3-trifluorobenzene, 1,2,4-trifluorobenzene, 1,3,5-trifluorobenzene, 1,2,3,4-tetrafluorobenzene, 1,2,3,5-tetrafluorobenzene, 1,2,4,5-tetrafluorobenzene, pentafluorobenzene, hexafluorobenzene, 2-fluorobenzaldehyde, 3-fluorobenzaldehyde, 4-fluorobenzaldehyde, 2-fluorobenzonitriles, 3-fluorobenzonitriles, 4-fluorobenzonitriles, 2-fluorostyrene, 3-fluorostyrene, 4-fluorostyrene, 2-fluorotoluene, 3-fluorotoluene, 4-fluorotoluene, trifluorotoluene, perfluorooctane, perfluoro-2-methylpentane, perfluoro-1,3-dimethylcyclohexane, perfluorodecalin, perfluoropentane, perfluoromethylcyclohexane, fluorocyclohexane, fluorocyclopropane, perfluorotripentylamine,1,1,2-trichloro-1,2,2-trifluoroethane, and combinations thereof.

10. The prepolymer electrolyte composition of any of specific examples 7-9, further comprising an additive selected from the group consisting of: trivinylcyclotriboroxane (tVCBO), vinylene carbonate (VC), ethyl methyl sulfone, tetramethyl sulfone (TMS), prop-1-ene-1,3-sulfone (PES), 1,3-propane sultone (PS), 1,4-butane sultone, propenyl-1,3-sultone, cyclic sulfate, dioxolane, 5-methyl-4-((trifluoromethoxy)methyl)-1,3-dioxol-2-one, phenyl boronic acid glycol ester (PBE), 5-methyl-4-((trimethylsilyloxy)methyl)-1,3-dioxol-2-one, succinonitrile (SN), malononitrile, glutaronitrile, adiponitrile (ADN), 1,1-bis(20cyanoethoxy) ethane, 1,1-dicyano-2-butene, hexane-1,3,6-tricarbonitrile, 1,2,3-tris(2-cyanoethoxy) propane, acetonitrile, benzonitrile, phthalonitrile, isobutyronitrile, cyanoform, dimethoxydimethylsilane, methyltrimethoxysilane, tetramethoxysilane, dimethylethoxysilane, triethylsilyl fluoromethanesulfonate, ethyltriacetoxysilane, diphenylmethoxysilane, difluorodiphenylsilane, lithium difluorophosphate, difluoro ethylene carbonate, 4-vinyl-1,3-dioxolan-2-one, tris(trimethylsilyl)phosphite, tris(trimethylsilyl)Phosphate, tris(trimethylsilyl)borate, vinyltris(2-methoxyethoxy) silane, 2-cyanoethyltriethoxysilane, tetraethyl orthosilicate, tripropargyl phosphate, methylene methanedisulfonate, 2,2,2-trifluoro-N,N-dimethylacetamide, 4-fluoro-N,N-dimethylbenzenesulfonamide, N—N-heptafluorobutyric anhydride, and combinations thereof.

11. The prepolymer electrolyte composition of any of specific examples 7-10, further comprising a plasticizer that hinders the salt from coordinating with the polymer precursor and crashing out of solution.

12. The prepolymer electrolyte composition of any of specific examples 7-11, wherein the polymer precursor further comprises a monoacrylate, monomethacrylate, or vinyl monomer (e.g., vinyl benzene or derivative thereof).

13 The prepolymer electrolyte composition of specific example 12, wherein an average number of acrylate and methacrylate groups per molecule (as averaged across the entirety of the polymerizable molecules of the polymer precursor) of the polymer precursor is between 1.5 and 2.1.

14. The prepolymer electrolyte composition of any of specific examples 7-13, wherein the diacrylate or the dimethacrylate comprises one or more hydrogen bond donors and one or more hydrogen bond acceptors, wherein the diacrylate or the dimethacrylate comprises more hydrogen bond accepting moieties than hydrogen bond donating moieties.

15. A prepolymer electrolyte composition comprising: a salt; an ionic liquid, wherein the salt is dissolved in the ionic liquid; a polymer precursor mixture comprising at least one multifunctional cross-linking monomer (e.g., diacrylates or dimethacrylates), wherein the polymer precursor is dissolved in the ionic liquid.

16. The prepolymer electrolyte composition of specific example 14, wherein an anion of the ionic liquid and an anion of the salt are the same.

17. The prepolymer electrolyte composition of any of specific examples 15-16, wherein a cation of the ionic liquid is selected from the group consisting of: 1-alkyl-3-methyl imidazolium, N-alkyl pyridinium, N-alkyl-N-methyl piperidinium, tetraalkyl-ammonium, tetraalkyl phosphonium, N-alkyl-N-methyl pyrrolidinium, 1,2-dialkyl-pyrazolium, N-alkyl-thiazolium, trialkylsulfonium, and combinations thereof; and wherein an anion of the ionic liquid is selected from the group consisting of: from hexafluorophosphate, tetrafluoroarsenate, perchlorate, tetrafluoroborate, triflate, chloride, bromide, iodide, tris(pentafluoroethyl)trifluorophosphate, bis(fluorosulfonyl)imide, cyclo-difluoromethane-1,1-bis(sulfonyl)imide, cyclo-hexafluoropropane-1,1-bis(sulfonyl)imide, bis(trifluorosulfonyl)imide, cyclo-hexafluoropropane-1,1-bis(sulfonyl)imide, bis(oxalate)borate, difluoro (oxalato)borate, bis(monofluoromalonato)borate, tetracyanoborate, 4,5-dicyano-1,2,3-triazolate, 2-trifluoromethyl-4,5-dicyanoimidazole, 4,5-dicyano-2-(pentafluorylethyl)imidazole, and combinations thereof; wherein each alkyl group can be independently selected from methyl, ethyl, propyl, butyl, pentyl, hexyl, heptyl, octyl, nonyl, decyl, undecyl, dodecyl, aryl, naphthyl group or variations of the preceding with one or more hydrogen atom replaced with a fluorine atom.

18. The prepolymer electrolyte any of specific examples 15-17, further comprising an additive selected from the group consisting of: fluoroethylene carbonate (FEC), trivinylcyclotriboroxane (tVCBO), vinylene carbonate (VC), sulfone, 1,3,2-Dioxathiolan-2,2-oxide (DTD), ethyl methyl sulfone, tetramethyl sulfone (TMS), prop-1-ene-1,3-sulfone (PES), 1,3-propane sultone (PS), 1,4-butane sultone, propenyl-1,3-sultone, cyclic sulfate, dioxolane, 5-methyl-4-((trifluoromethoxy)methyl)-1,3-dioxol-2-one, phenyl boronic acid glycol ester (PBE), 5-methyl-4-((trimethylsilyloxy)methyl)-1,3-dioxol-2-one, trimethylphosphate (TMP), triethylphosphate (TEP), tributylphosphate (TBP), triphenylphosphate (TPP), tris(2,2,2-trifluoroethyl)phosphate (TFP), methyl P,P-bis(2,2,2-trifluoroethyl)phosphate (BMP), trimethylphosphite (TMPi), tris(2,2,2-trifluoroethyl)phosphite (TTFPi), dimethyl methyl phosphate (DMMP), diethyl ethylphosphate (DEEP), bis(2,2,2-trifluoroethyl)methylphosphate (TFMP), bis(2,2,2-trifluoroethyl)ethylphosphate (TFEP), hexa(methoxy)cyclotriphosphazene (HMOCPN), (ethoxy)pentafluorocyclotriphosphazene (PFPN), (phenoxy)pentafluorocyclotriphosphazene (FPPN), tris(trimethylsilyl)phosphite (TMSPi), succinonitrile (SN), malononitrile, glutaronitrile, adiponitrile (ADN), 1,1-bis(20cyanoethoxy) ethane, 1,1-dicyano-2-butene, hexane-1,3,6-tricarbonitrile, 1,2,3-tris(2-cyanoethoxy) propane, acetonitrile, benzonitrile, phthalonitrile, isobutyronitrile, cyanoform, dimethoxydimethylsilane, methyltrimethoxysilane, tetramethoxysilane, dimethylethoxysilane, triethylsilyl fluoromethanesulfonate, ethyltriacetoxysilane, diphenylmethoxysilane, difluorodiphenylsilane, fluoroethylene carbonate (FEC), lithium difluorophosphate, ethylene sulfate (DTD), difluoro ethylene carbonate, 4-vinyl-1,3-dioxolan-2-one, tris(trimethylsilyl)phosphite, tris(trimethylsilyl)Phosphate, tris(trimethylsilyl)borate, vinyltris(2-methoxyethoxy) silane, 2-cyanoethyltriethoxysilane, tetraethyl orthosilicate, tripropargyl phosphate, methylene methanedisulfonate, 2,2,2-trifluoro-N,N-dimethylacetamide, 4-fluoro-N,N-dimethylbenzenesulfonamide, N—N-heptafluorobutyric anhydride, and combinations thereof.

19. The prepolymer electrolyte composition of any of specific examples 15-18, wherein the polymer precursor further comprises a monoacrylate, monomethacrylate, or vinyl monomer (e.g., vinyl benzene or derivative thereof).

20. The prepolymer electrolyte composition of specific example 19, wherein an average number of acrylate and methacrylate groups per molecule of the polymer precursor is between 1.5 and 2.1.

21. The prepolymer electrolyte composition of any of specific examples 15-20, wherein the polymer precursor comprises a molecule with a structure given by

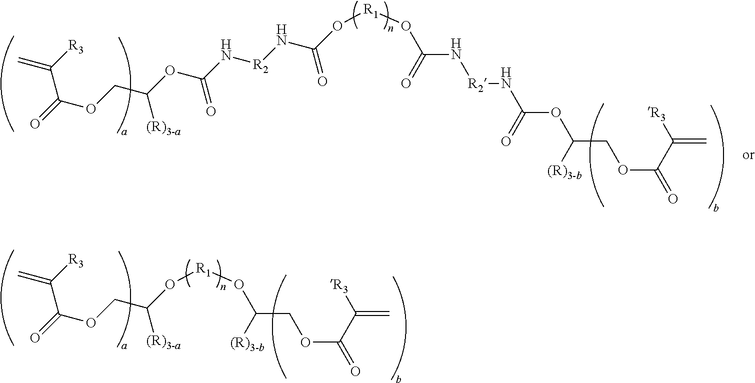

where R1 is selected from:

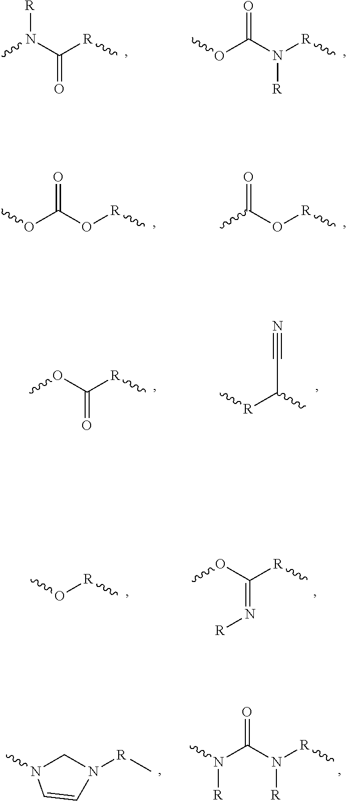

or combinations thereof; where R2 and R2′ are each independently selected from the group consisting of:

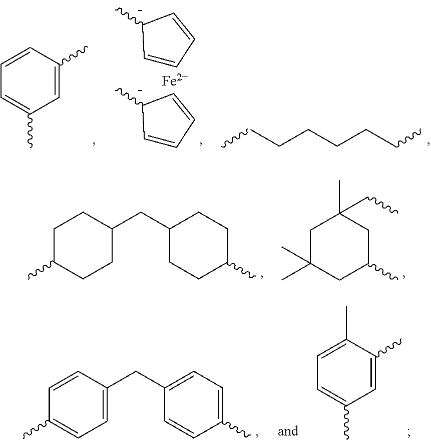

where R3 and R3′ are each independently selected from hydrogen, methyl, and ethyl; and where each R is independently selected from: a substituted or unsubstituted alkylene group having 1 to 40 carbon atoms, a substituted or unsubstituted cycloalkylene group having 4 to 40 carbon atoms, and a substituted or unsubstituted arylene group having 6 to 40 carbon atoms; where n is the number of repeat or individual monomer units, where n is a value between 1 and 1000; and where a and b are each independently between 0 and 3, where at least one of a or b is not 0.

22. The prepolymer electrolyte composition of any of specific examples 15-21, further comprising a plasticizer that hinders the salt from coordinating with the polymer precursor and crashing out of solution.

23. A method for curing the prepolymer electrolyte composition of any of specific examples 7-22 to form a gel or polymer electrolyte (e.g., interspersed through a cathode, anode, and separator of a battery cell, between and contacting a surface of but not interspersed through the cathode and anode of a battery cell, etc.).

24. A method for forming the prepolymer electrolyte composition of any of specific examples 1-22.

25. A battery formed from the method of any of specific examples 1-6 or 23.

26. The prepolymer electrolyte composition of any of specific examples 1-25, wherein the polymer precursor mixture or the polymer precursor solution comprises: 10-30 wt % salt-dissolving solvent (e.g., flame retardant solvent), 10-35 wt % salt, 30-90 wt % diluent (e.g., nonpolar solvent), 1-20 wt % polymer precursor (inclusive of monoacrylates, diacrylates, monomethacrylates, dimethacrylates, cross-linking monomers, etc.), where the salt concentration is between 10-60 wt % salt in the salt-dissolving solvent (e.g., ionic liquid, ionic liquid and second polar solvent, polar solvent, etc.).

27. The prepolymer electrolyte composition of any of specific examples 1 or 3-26 wherein the polymer precursor mixture or the polymer precursor solution further comprises an initiator selected from the group consisting of: dimethyl 2,2′-azobis(2-methylpropionate, 2,2′-azobis(2,4-dimethyl-4-methoxyvaleronitrile), 1,1′-azobis(cyclohexanecarbonitrile) (ACHN), azobisisobutylonitrile (AIBN), 1,1′-azobis-1,2,3-triazole, 2,2′-azobis(2,4-dimethylvaleronitrile), 2,2-azobis(2-methylbutyronitrile), 2,2′-azobis(N-butyl-2-methyl propionamide), 2,2′-azobis(2,4,5-trimethylpentane), 2,2′-azobis[2-(2-imidazolin-2-yl) propane]dihydrochloride, di-tert-butyl peroxide, benzoyl peroxide, methyl ethyl ketone peroxide, acetone peroxide, tert-butyl hydroperoxide, cumene hydroperoxide, dicumyl peroxide, ammonium persulfate, and combinations thereof.

28. The prepolymer electrolyte composition of specific example 26 or 27, wherein the polymer precursor mixture or the polymer precursor solution comprises 0.1 to 1 wt % of the initiator.

29. The prepolymer electrolyte composition of any of specific examples 1-28 wherein the polymer precursor mixture or the polymer precursor solution further comprises an additive or a plasticizer selected from the group consisting of: fluoroethylene carbonate (FEC), trivinylcyclotriboroxane (tVCBO), vinylene carbonate (VC), sulfone, 1,3,2-Dioxathiolan-2,2-oxide (DTD), ethyl methyl sulfone, tetramethyl sulfone (TMS), prop-1-ene-1,3-sulfone (PES), 1,3-propane sultone (PS), 1,4-butane sultone, propenyl-1,3-sultone, cyclic sulfate, dioxolane, 5-methyl-4-((trifluoromethoxy)methyl)-1,3-dioxol-2-one, phenyl boronic acid glycol ester (PBE), 5-methyl-4-((trimethylsilyloxy)methyl)-1,3-dioxol-2-one, trimethylphosphate (TMP), triethylphosphate (TEP), tributylphosphate (TBP), triphenylphosphate (TPP), tris(2,2,2-trifluoroethyl)phosphate (TFP), methyl P,P-bis(2,2,2-trifluoroethyl)phosphate (BMP), trimethylphosphite (TMPi), tris(2,2,2-trifluoroethyl)phosphite (TTFPi), dimethyl methyl phosphate (DMMP), diethyl ethylphosphate (DEEP), bis(2,2,2-trifluoroethyl)methylphosphate (TFMP), bis(2,2,2-trifluoroethyl)ethylphosphate (TFEP), hexa(methoxy)cyclotriphosphazene (HMOCPN), (ethoxy)pentafluorocyclotriphosphazene (PFPN), (phenoxy)pentafluorocyclotriphosphazene (FPPN), tris(trimethylsilyl)phosphite (TMSPi), succinonitrile (SN), malononitrile, glutaronitrile, adiponitrile (ADN), 1,1-bis(20cyanoethoxy) ethane, 1,1-dicyano-2-butene, hexane-1,3,6-tricarbonitrile, 1,2,3-tris(2-cyanoethoxy) propane, acetonitrile, benzonitrile, phthalonitrile, isobutyronitrile, cyanoform, dimethoxydimethylsilane, methyltrimethoxysilane, tetramethoxysilane, dimethylethoxysilane, triethylsilyl fluoromethanesulfonate, ethyltriacetoxysilane, diphenylmethoxysilane, difluorodiphenylsilane, and combinations thereof.

30. The prepolymer electrolyte composition of specific example 28 or 29, wherein the polymer precursor mixture or the polymer precursor solution comprises 1 to 10 wt % of the additive or plasticizer (e.g., surfactant).

31. The prepolymer electrolyte composition of any of specific examples 1-30, wherein the salt is selected from the group consisting of: lithium hexafluorophosphate (LiPF₆), lithium tetrafluoroarsenate (LiAsF₆), lithium perchlorate (LiClO₄), lithium tetrafluoroborate (LiBF₄), lithium triflate (LiCF₃SO₃), lithium tris(pentafluoroethyl)trifluorophosphate (LiFAP), lithium bis(fluorosulfonyl)imide (LiFSI), lithium-cyclo-difluoromethane-1,1-bis(sulfonyl)imide (LiDMSI), lithium-cyclo-hexafluoropropane-1,1-bis(sulfonyl)imide (LiHPSI), lithium bis(trifluorosulfonyl)imide (LiTFSI), lithium-cyclo-hexafluoropropane-1,1-bis(sulfonyl)imide (LiBETI), lithium bis(oxalate)borate (LiBOB), lithium difluoro (oxalato)borate (LiDFOB), lithium bis(monofluoromalonato)borate (LiBFMB), lithium tetracyanoborate (LiB(CN)₄), lithium 4,5-dicyano-1,2,3-triazolate (LiDCTA), lithium 2-trifluoromethyl-4,5-dicyanoimidazole (LiTDI), lithium 4,5-dicyano-2-(pentafluorylethyl)imidazole (LiPDI), sodium hexafluorophosphate (NaPF₆), sodium hexafluoroarsenate (NaAsF₆), sodium tetrafluoroborate (NaBF₄), sodium perchlorate (NaClO₄), sodium tetracyanoborate (NaB(CN)₄), sodium bis(fluorosulfonyl)imide (NaFSI), sodium bis(trifluorosulfonyl)imide (NaTFSI), sodium tris(trifluoromethanesulfonyl)methide (NaTFSM), sodium bis(oxalate)borate (NaBOB), sodium difluoro (oxalato)borate (NaDFOB), sodium fluoroalkylphoshpates, sodiumtris(pentafluoroethyl)trifluorophosphate), sodium-cyclo-difluoromethane-1,1-bis(sulfonyl)imide (NaDMSI), sodium-cyclo-hexafluoropropane-1,1-bis(sulfonyl)imide (NaHPSI), sodium-cyclo-hexafluoropropane-1,1-bis(sulfonyl)imide (NaBETI), sodium bis(monofluoromalonato)borate (NaBFMB), sodium 4,5-dicyano-1,2,3-triazolate (NaDCTA), sodium 2-trifluoromethyl-4,5-dicyanoimidazole (NaTDI), sodium 4,5-dicyano-2-(pentafluorylethyl)imidazole (NaPDI), sodium tris(pentafluoroethyl)trifluorophosphate (NaFAP), potassium hexafluorophosphate (KPF₆), potassium hexafluoroarsenate (KAsF₆), potassium tetrafluoroborate (KBF₄), potassium perchlorate (KClO₄), potassium tetracyanoborate (KB(CN)₄), potassium bis(fluorosulfonyl)imide (KFSI), potassium bis(trifluorosulfonyl)imide (KTFSI), potassium tris(trifluoromethanesulfonyl)methide (KTFSM), potassium bis(oxalate)borate (KBOB), potassium difluoro (oxalato)borate (KDFOB), potassium fluoroalkylphoshpates, potassium tris(pentafluoroethyl)trifluorophosphate), potassium-cyclo-difluoromethane-1,1-bis(sulfonyl)imide (KDMSI), potassium-cyclo-hexafluoropropane-1,1-bis(sulfonyl)imide (KHPSI), potassium-cyclo-hexafluoropropane-1,1-bis(sulfonyl)imide (KBETI), potassium bis(monofluoromalonato)borate (KBFMB), potassium 4,5-dicyano-1,2,3-triazolate (KDCTA), potassium 2-trifluoromethyl-4,5-dicyanoimidazole (KTDI), potassium 4,5-dicyano-2-(pentafluorylethyl)imidazole (KPDI), potassium tris(pentafluoroethyl)trifluorophosphate (KFAP), ammonium hexafluorophosphate, ammonium hexafluoroarsenate, ammonium tetrafluoroborate, ammonium perchlorate, ammonium tetracyanoborate, ammonium bis(fluorosulfonyl)imide, ammonium bis(trifluorosulfonyl)imide, ammonium tris(trifluoromethanesulfonyl)methide, ammonium bis(oxalate)borate, ammonium fluoroalkylphoshpates, ammonium tris(pentafluoroethyl)trifluorophosphate), ammonium-cyclo-difluoromethane-1,1-bis(sulfonyl)imide, ammonium-cyclo-hexafluoropropane-1,1-bis(sulfonyl)imide, ammonium-cyclo-hexafluoropropane-1,1-bis(sulfonyl)imide, ammonium difluoro (oxalato)borate, ammonium bis(monofluoromalonato)borate, ammonium 4,5-dicyano-1,2,3-triazolate, ammonium 2-trifluoromethyl-4,5-dicyanoimidazole, ammonium 4,5-dicyano-2-(pentafluorylethyl)imidazole, ammonium tris(pentafluoroethyl)trifluorophosphate, and combinations thereof.

We claim:

1. A method for forming a battery cell comprising:
wetting an anode, a cathode, and a separator with a polymer precursor solution, wherein the polymer precursor solution comprises:
a salt;
an ionic liquid, wherein the salt is dissolved in the ionic liquid;
a diluent, wherein a solubility of the salt in the diluent is at most one tenth that of the solubility of the salt in the ionic liquid; and
a polymer precursor mixture comprising at least one multifunctional cross-linking monomer, wherein the polymer precursor is dissolved in the ionic liquid and the diluent;
sealing the battery cell; and
curing the polymer precursor to form a gel electrolyte throughout the anode, the cathode, and the separator.

2. The method of claim 1, wherein the polymer precursor solution further comprises an initiator selected from the group consisting of: dimethyl 2,2′-azobis(2-methylpropionate, 2,2′-azobis(2,4-dimethyl-4-methoxyvaleronitrile), 1,1′-azobis(cyclohexanecarbonitrile) (ACHN), azobisisobutylonitrile (AIBN), 1,1′-azobis-1,2,3-triazole, 2,2′-azobis(2,4-dimethylvaleronitrile), 2,2-azobis(2-methylbutyronitrile), 2,2′-azobis(N-butyl-2-methyl propionamide), 2,2′-azobis(2,4,5-trimethylpentane), 2,2′-azobis[2-(2-imidazolin-2-yl) propane]dihydrochloride, di-tert-butyl peroxide, benzoyl peroxide, methyl ethyl ketone peroxide, acetone peroxide, tert-butyl hydroperoxide, cumene hydroperoxide, dicumyl peroxide, ammonium persulfate, and combinations thereof;
wherein curing the polymer precursor comprises thermally forming free radicals from the initiator.

3. The method of claim 1, wherein the polymer precursor solution further comprises a plasticizer that hinders the salt from coordinating with the polymer precursor and crashing out of solution.

4. The method of claim 3, wherein the plasticizer is selected from the group consisting of: ethylene carbonate (EC), propylene carbonate (PC), fluoroethylene carbonate (FEC), triglyme, tetraglyme, methyl propionate (MP), methyl butanoate (MB), ethyl propionate (EP), ethyl butanoate (EB), propyl propionate (PP), ethylene sulfite, sulfolane, trimethylphosphate (TMP), triethylphosphate (TEP), tributylphosphate (TBP), triphenylphosphate (TPP), dimethyl methyl phosphate (DMMP), diethyl ethylphosphate (DEEP), trimethylphosphite (TMPi), triethylphosphite (TEPi), phosphazenes, fluorosurfactants, γ-butyrolactone (GBL), dimethylacetamide (DMAc), N-methyl-2-pyrrolidone (NMP), and combinations thereof.

5. The method of claim 1, wherein the diluent is selected from the group comprising: (ethoxy)pentafluorocyclotriphosphazene (PFPN), (phenoxy)pentafluorocyclotriphosphazene (FPPN), tris(2,2,2-trifluoroethyl)phosphate (TFP), bis(2,2,2-trifluoroethyl)methylphosphate (TFMP), bis(2,2,2-trifluoroethyl)ethylphosphate (TFEP), tris(2,2,2-trifluoroethyl)borate (TTFEB), tris(2,2,2-trifluoroethyl)phosphite (TTFPi), methyl 3,3,3-trifluoropropanoate (MTFP), ethyl trifluoroacetate (ETFA), 2,2,2-trifluoroethylacetate (TFEA), methyl pentafluoropropionate (MPFP), ethyl 3,3,3-trifluoropyruvate (ETFPy), tris(2-fluoroethyl)borate (TFEB), methyl 2,2,2-trifluoroethyl carbonate (MTFEC), ethyl 2,2,2-trifluoroethyl carbonate (ETFEC), propyl 2,2,2-trifluoroethyl carbonate (PTFEC), methyl 2,2,2,2′,2′,2′-hexafluoro-isopropyl carbonate (MHFPC), ethyl 2,2,2,2′,2′,2′-hexafluoro-isopropyl carbonate (EHFPC), di-2,2,2-trifluoroethyl carbonate (DTFEC), trifluoropropylene carbonate (TFPC), trifluorobutylene carbonate (TFBC), difluorovinyl carbonate (DFVC), trifluoroethyl methyl carbonate (TFEMC), bis(2,2,2-trifluoroethyl) carbonate (DFDEC), bis(2,2,2-trifluoroethyl) ether (BTFE), 1,1,2,2-tetrafluoroethyl 2,2,2 trifluoroethyl ether, ethyl nonafluorobutyl ether, methyl nonafluorobutyl ether, difluoromethyl 2,2,3,3-tetrafluoropropyl ether, 1,1,1,2,2,3,4,5,5,5-decafluoro-2-methoxy-4 (trifluoromethyl)pentane, ethyl 1,1,2,2-tetrafluoroethyl ether, ethyl 1,1,2,3,3,3-hexafluoropropyl ether, fluoromethyl 1,1,1,3,3,3-hexafluoroisopropyl ether, 1,1,2,3,3,3-hexafluoropropyl methyl ether, hexafluoroisopropyl methyl ether, methyl 2,2,3,3,3-pentafluoropropyl ether, methyl 1,1,2,2-tetrafluoroethyl ether, 1H,1H,5H-octafluoropentyl 1,1,2,2-tetrafluoroethyl ether, 3,3,4,4-tetrafluorotetrahydrofuran, 1,1,2,2-tetrafluoroethyl-2,2,3,3-tetrafluoropropyl ether (TTE), 2,2-dimethoxy-4-(trifluoromethyl)-1,3-dioxolane (DTDL), tris(2,2,2-trifluoroethyl)orthoformate (TFEO), hexafluoropropylene oxide, perfluoroether (PFE), hydrofluorethers (HFE), monofluorobenzene, 1,2-difluorobenzene, 1,3-difluorobenzene, 1,4-difluorobenzene, 1,2,3-trifluorobenzene, 1,2,4-trifluorobenzene, 1,3,5-trifluorobenzene, 1,2,3,4-tetrafluorobenzene, 1,2,3,5-tetrafluorobenzene, 1,2,4,5-tetrafluorobenzene, pentafluorobenzene, hexafluorobenzene, 2-fluorobenzaldehyde, 3-fluorobenzaldehyde, 4-fluorobenzaldehyde, 2-fluorobenzonitriles, 3-fluorobenzonitriles, 4-fluorobenzonitriles, 2-fluorostyrene, 3-fluorostyrene, 4-fluorostyrene, 2-fluorotoluene, 3-fluorotoluene, 4-fluorotoluene, trifluorotoluene, perfluorooctane, perfluoro-2-methylpentane, perfluoro-1,3-dimethylcyclohexane, perfluorodecalin, perfluoropentane, perfluoromethylcyclohexane, fluorocyclohexane, fluorocyclopropane, perfluorotripentylamine,1,1,2-trichloro-1,2,2-trifluoroethane, and combinations thereof.

6. The method of claim 1, wherein a cation of the ionic liquid is selected from the group consisting of: 1-alkyl-3-methyl imidazolium, N-alkyl pyridinium, N-alkyl-N-methyl piperidinium, tetraalkyl-ammonium, tetraalkyl phosphonium, N-alkyl-N-methyl pyrrolidinium, 1,2-dialkyl-pyrazolium, N-alkyl-thiazolium, trialkylsulfonium, and combinations thereof; and wherein an anion of the ionic liquid is selected from the group consisting of: from hexafluorophosphate, tetrafluoroarsenate, perchlorate, tetrafluoroborate, triflate, chloride, bromide, iodide, tris(pentafluoroethyl)trifluorophosphate, bis(fluorosulfonyl)imide, cyclo-difluoromethane-1,1-bis(sulfonyl)imide, cyclo-hexafluoropropane-1,1-bis(sulfonyl)imide, bis(trifluorosulfonyl)imide, cyclo-hexafluoropropane-1,1-bis(sulfonyl)imide, bis(oxalate)borate, difluoro (oxalato)borate, bis(monofluoromalonato)borate, tetracyanoborate, 4,5-dicyano-1,2,3-triazolate, 2-trifluoromethyl-4,5-dicyanoimidazole, 4,5-dicyano-2-(pentafluorylethyl)imidazole, and combinations thereof; wherein each alkyl group can be independently selected from methyl, ethyl, propyl, butyl, pentyl, hexyl, heptyl, octyl, nonyl, decyl, undecyl, dodecyl, aryl, naphthyl group or variations of the preceding with one or more hydrogen atom replaced with a fluorine atom.

7. A prepolymer electrolyte composition comprising:
a salt;
a polar solvent, wherein the salt is dissolved in the polar solvent to a concentration between 10 and 80 wt %;
a diluent, wherein a solubility of the salt in the diluent is at most one tenth that of the solubility of the salt in the polar solvent; and
a polymer precursor mixture comprising at least one multifunctional cross-linking monomer.

8. The prepolymer electrolyte composition of claim 7, wherein the polar solvent is selected from: ethylene carbonate (EC), propylene carbonate (PC), fluoroethylene carbonate (FEC), triglyme, tetraglyme, methyl propionate (MP), ethyl propionate (EP), ethyl butanoate (EB), propyl propionate (PP), methyl butanoate (MB), ethylene sulfite, sulfolane, trimethylphosphate (TMP), triethylphosphate (TEP), tributylphosphate (TBP), triphenylphosphate (TPP), dimethyl methyl phosphate (DMMP), diethyl ethylphosphate (DEEP), trimethylphosphite (TMPi), triethylphosphite (TEPi), phosphazenes, γ-butyrolactone (GBL), dimethylacetamide (DMAc), N-methyl-2-pyrrolidone (NMP), or combinations thereof.

9. The prepolymer electrolyte composition of claim 8, wherein the diluent is selected from: (ethoxy)pentafluorocyclotriphosphazene (PFPN), (phenoxy)pentafluorocyclotriphosphazene (FPPN), tris(2,2,2-trifluoroethyl)phosphate (TFP), bis(2,2,2-trifluoroethyl)methylphosphate (TFMP), bis(2,2,2-trifluoroethyl)ethylphosphate (TFEP), tris(2,2,2-trifluoroethyl)borate (TTFEB), tris(2,2,2-trifluoroethyl)phosphite (TTFPi), methyl 3,3,3-trifluoropropanoate (MTFP), ethyl trifluoroacetate (ETFA), 2,2,2-trifluoroethylacetate (TFEA), methyl pentafluoropropionate (MPFP), ethyl 3,3,3-trifluoropyruvate (ETFPy), tris(2-fluoroethyl)borate (TFEB), methyl 2,2,2-trifluoroethyl carbonate (MTFEC), ethyl 2,2,2-trifluoroethyl carbonate (ETFEC), propyl 2,2,2-trifluoroethyl carbonate (PTFEC), methyl 2,2,2,2′,2′,2′-hexafluoro-isopropyl carbonate (MHFPC), ethyl 2,2,2,2′,2′,2′-hexafluoro-isopropyl carbonate (EHFPC), di-2,2,2-trifluoroethyl carbonate (DTFEC), trifluoropropylene carbonate (TFPC), trifluorobutylene carbonate (TFBC), difluorovinyl carbonate (DFVC), trifluoroethyl methyl carbonate (TFEMC), bis(2,2,2-trifluoroethyl) carbonate (DFDEC), bis(2,2,2-trifluoroethyl) ether (BTFE), 1,1,2,2-tetrafluoroethyl 2,2,2 trifluoroethyl ether, ethyl nonafluorobutyl ether, methyl nonafluorobutyl ether, difluoromethyl 2,2,3,3-tetrafluoropropyl ether, 1,1,1,2,2,3,4,5,5,5-decafluoro-2-methoxy-4 (trifluoromethyl)pentane, ethyl 1,1,2,2-tetrafluoroethyl ether, ethyl 1,1,2,3,3,3-hexafluoropropyl ether, fluoromethyl 1,1,1,3,3,3-hexafluoroisopropyl ether, 1,1,2,3,3,3-hexafluoropropyl methyl ether, hexafluoroisopropyl methyl ether, methyl 2,2,3,3,3-pentafluoropropyl ether, methyl 1,1,2,2-tetrafluoroethyl ether, 1H,1H,5H-octafluoropentyl 1,1,2,2-tetrafluoroethyl ether, 3,3,4,4-tetrafluorotetrahydrofuran, 1,1,2,2-tetrafluoroethyl-2,2,3,3-tetrafluoropropyl ether (TTE), 2,2-dimethoxy-4-(trifluoromethyl)-1,3-dioxolane (DTDL), tris(2,2,2-trifluoroethyl)orthoformate (TFEO), hexafluoropropylene oxide, perfluoroether (PFE), hydrofluorethers (HFE), monofluorobenzene, 1,2-difluorobenzene, 1,3-difluorobenzene, 1,4-difluorobenzene, 1,2,3-trifluorobenzene, 1,2,4-trifluorobenzene, 1,3,5-trifluorobenzene, 1,2,3,4-tetrafluorobenzene, 1,2,3,5-tetrafluorobenzene, 1,2,4,5-tetrafluorobenzene, pentafluorobenzene, hexafluorobenzene, 2-fluorobenzaldehyde, 3-fluorobenzaldehyde, 4-fluorobenzaldehyde, 2-fluorobenzonitriles, 3-fluorobenzonitriles, 4-fluorobenzonitriles, 2-fluorostyrene, 3-fluorostyrene, 4-fluorostyrene, 2-fluorotoluene, 3-fluorotoluene, 4-fluorotoluene, trifluorotoluene, perfluorooctane, perfluoro-2-methylpentane, perfluoro-1,3-dimethylcyclohexane, perfluorodecalin, perfluoropentane, perfluoromethylcyclohexane, fluorocyclohexane, fluorocyclopropane, perfluorotripentylamine,1,1,2-trichloro-1,2,2-trifluoroethane, and combinations thereof.

10. The prepolymer electrolyte composition of claim 9, further comprising an additive selected from the group consisting of: trivinylcyclotriboroxane (tVCBO), vinylene carbonate (VC), ethyl methyl sulfone, tetramethyl sulfone (TMS), prop-1-ene-1,3-sulfone (PES), 1,3-propane sultone (PS), 1,4-butane sultone, propenyl-1,3-sultone, cyclic sulfate, dioxolane, 5-methyl-4-((trifluoromethoxy)methyl)-1,3-dioxol-2-one, phenyl boronic acid glycol ester (PBE), 5-methyl-4-((trimethylsilyloxy)methyl)-1,3-dioxol-2-one, succinonitrile (SN), malononitrile, glutaronitrile, adiponitrile (ADN), 1,1-bis(20cyanoethoxy) ethane, 1,1-dicyano-2-butene, hexane-1,3,6-tricarbonitrile, 1,2,3-tris(2-cyanoethoxy) propane, acetonitrile, benzonitrile, phthalonitrile, isobutyronitrile, cyanoform, dimethoxydimethylsilane, methyltrimethoxysilane, tetramethoxysilane, dimethylethoxysilane, triethylsilyl fluoromethanesulfonate, ethyltriacetoxysilane, diphenylmethoxysilane, difluorodiphenylsilane, lithium difluorophosphate, difluoro ethylene carbonate, 4-vinyl-1,3-dioxolan-2-one, tris(trimethylsilyl)phosphite, tris(trimethylsilyl)Phosphate, tris(trimethylsilyl)borate, vinyltris(2-methoxyethoxy) silane, 2-cyanoethyltriethoxysilane, tetraethyl orthosilicate, tripropargyl phosphate, methylene methanedisulfonate, 2,2,2-trifluoro-N,N-dimethylacetamide, 4-fluoro-N,N-dimethylbenzenesulfonamide, N—N-heptafluorobutyric anhydride, and combinations thereof.

11. The prepolymer electrolyte composition of claim 7, wherein the polymer precursor further comprises a monofunctional monomer.

12. The prepolymer electrolyte composition of claim 11, wherein an average number of functional groups per molecule of the polymer precursor is between 1.5 and 2.1.

13. The prepolymer electrolyte composition of claim 7, wherein the at least one multifunctional cross-linking monomer comprises one or more hydrogen bond donors and one or more hydrogen bond acceptors, wherein the diacrylate or the dimethacrylate comprises more hydrogen bond accepting moieties than hydrogen bond donating moieties.

14. A prepolymer electrolyte composition comprising:
a salt;
an ionic liquid, wherein the salt is dissolved in the ionic liquid;
a polymer precursor mixture comprising at least one multifunctional cross-linking monomer, wherein the polymer precursor is dissolved in the ionic liquid.

15. The prepolymer electrolyte composition of claim 14, wherein an anion of the ionic liquid and an anion of the salt are the same.

16. The prepolymer electrolyte composition of claim 14, wherein a cation of the ionic liquid is selected from the group consisting of: 1-alkyl-3-methyl imidazolium, N-alkyl pyridinium, N-alkyl-N-methyl piperidinium, tetraalkyl-ammonium, tetraalkyl phosphonium, N-alkyl-N-methyl pyrrolidinium, 1,2-dialkyl-pyrazolium, N-alkyl-thiazolium, trialkylsulfonium, and combinations thereof; and wherein an anion of the ionic liquid is selected from the group consisting of: from hexafluorophosphate, tetrafluoroarsenate, perchlorate, tetrafluoroborate, triflate, chloride, bromide, iodide, tris(pentafluoroethyl)trifluorophosphate, bis(fluorosulfonyl)imide, cyclo-difluoromethane-1,1-bis(sulfonyl)imide, cyclo-hexafluoropropane-1,1-bis(sulfonyl)imide, bis(trifluorosulfonyl)imide, cyclo-hexafluoropropane-1,1-bis(sulfonyl)imide, bis(oxalate)borate, difluoro (oxalato)borate, bis(monofluoromalonato)borate, tetracyanoborate, 4,5-dicyano-1,2,3-triazolate, 2-trifluoromethyl-4,5-dicyanoimidazole, 4,5-dicyano-2-(pentafluorylethyl)imidazole, and combinations thereof; wherein each alkyl group can be independently selected from methyl, ethyl, propyl, butyl, pentyl, hexyl, heptyl, octyl, nonyl, decyl, undecyl, dodecyl, aryl, naphthyl group or variations of the preceding with one or more hydrogen atom replaced with a fluorine atom.

17. The prepolymer electrolyte of claim 16, further comprising an additive selected from the group consisting of: fluoroethylene carbonate (FEC), trivinylcyclotriboroxane (tVCBO), vinylene carbonate (VC), sulfone, 1,3,2-Dioxathiolan-2,2-oxide (DTD), ethyl methyl sulfone, tetramethyl sulfone (TMS), prop-1-ene-1,3-sulfone (PES), 1,3-propane sultone (PS), 1,4-butane sultone, propenyl-1,3-sultone, cyclic sulfate, dioxolane, 5-methyl-4-((trifluoromethoxy)methyl)-1,3-dioxol-2-one, phenyl boronic acid glycol ester (PBE), 5-methyl-4-((trimethylsilyloxy)methyl)-1,3-dioxol-2-one, trimethylphosphate (TMP), triethylphosphate (TEP), tributylphosphate (TBP), triphenylphosphate (TPP), tris(2,2,2-trifluoroethyl)phosphate (TFP), methyl P,P-bis(2,2,2-trifluoroethyl)phosphate (BMP), trimethylphosphite (TMPi), tris(2,2,2-trifluoroethyl)phosphite (TTFPi), dimethyl methyl phosphate (DMMP), diethyl ethylphosphate (DEEP), bis(2,2,2-trifluoroethyl)methylphosphate (TFMP), bis(2,2,2-trifluoroethyl)ethylphosphate (TFEP), hexa(methoxy)cyclotriphosphazene (HMOCPN), (ethoxy)pentafluorocyclotriphosphazene (PFPN), (phenoxy)pentafluorocyclotriphosphazene (FPPN), tris(trimethylsilyl)phosphite (TMSPi), succinonitrile (SN), malononitrile, glutaronitrile, adiponitrile (ADN), 1,1-bis(20cyanoethoxy) ethane, 1,1-dicyano-2-butene, hexane-1,3,6-tricarbonitrile, 1,2,3-tris(2-cyanoethoxy) propane, acetonitrile, benzonitrile, phthalonitrile, isobutyronitrile, cyanoform, dimethoxydimethylsilane, methyltrimethoxysilane, tetramethoxysilane, dimethylethoxysilane, triethylsilyl fluoromethanesulfonate, ethyltriacetoxysilane, diphenylmethoxysilane, difluorodiphenylsilane, lithium difluorophosphate, difluoro ethylene carbonate, 4-vinyl-1,3-dioxolan-2-one, tris(trimethylsilyl)phosphite, tris(trimethylsilyl)Phosphate, tris(trimethylsilyl)borate, vinyltris(2-methoxyethoxy) silane, 2-cyanoethyltriethoxysilane, tetraethyl orthosilicate, tripropargyl phosphate, methylene methanedisulfonate, 2,2,2-trifluoro-N,N-dimethylacetamide, 4-fluoro-N,N-dimethylbenzenesulfonamide, N—N-heptafluorobutyric anhydride, and combinations thereof.

18. The prepolymer electrolyte composition of claim 14, wherein the polymer precursor further comprises a monofunctional monomer.

19. The prepolymer electrolyte composition of claim 18, wherein an average number of acrylate and methacrylate groups per molecule of the polymer precursor is between 1.5 and 2.1.

20. The prepolymer electrolyte composition of claim 14, wherein the polymer precursor comprises a molecule with a structure given by 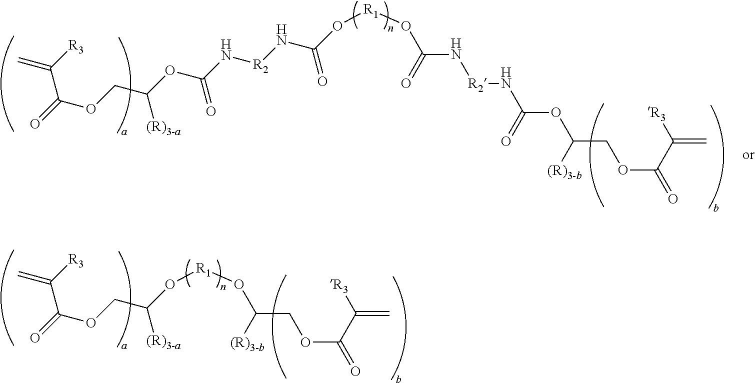
wherein R¹ is selected from: 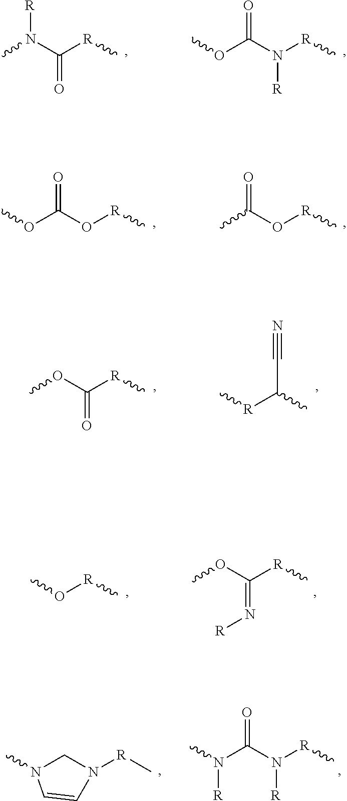
or combinations thereof;
wherein R2 and R2′ are each independently selected from the group consisting of: 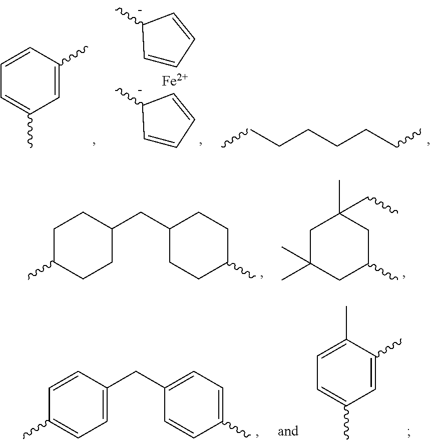
wherein R³ and R3′ are each independently selected from hydrogen, methyl, and ethyl; and
wherein each R is independently selected from: a substituted or unsubstituted alkylene group having 1 to 40 carbon atoms, a substituted or unsubstituted cycloalkylene group having 4 to 40 carbon atoms, and a substituted or unsubstituted arylene group having 6 to 40 carbon atoms; wherein n is the number of repeat or individual monomer units, where n is a value between 1 and 1000; and wherein a and b are each independently between 0 and 3, wherein at least one of a or b is not 0.
